(19) United States
(12) Patent Application Publication
(10) Pub. No.: US 2010/0072237 A1
(43) Pub. Date: Mar. 25, 2010

(54) Disassemblable Rack Having Dual Mounting Crossbars for Use with Pickup Trucks and SUVs

(76) Inventor: Christopher Phillip Green, Madera, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/603,573

(22) Filed: Oct. 21, 2009

Related U.S. Application Data
(63) Continuation-in-part of application No. 12/284,949, filed on Sep. 25, 2008.

(51) Int. Cl. B60R 9/00; B60P 3/00; B60R 9/04; B60R 9/058; B60R 9/06

(52) U.S. Cl. 224/405; 296/3

(57) ABSTRACT

A rack for pickup trucks, SUVs and other vehicles that is configured to carry cargo above the truck bed or roof of the vehicle. The rack is easily installed on and removed from the vehicle without requiring drilling or other modifications to the vehicle and is configured to carry heavy loads while utilizing lightweight materials. The rack comprises a span member and a pair of rack assemblies that support the span member. The span member has dual mounting crossbars that are configured with different cross-sections to support different types of accessory attachments utilized to support specific cargo on the rack. The rack assemblies each comprise a leg member, a span clamp assembly to clamp the upper end of the leg member to the span member and a clamping assembly that clamps the lower end of the leg member to the bedrails, accessory tracks or cargo rails of the vehicle.

### CROSS-REFERENCE TO RELATED APPLICATIONS

This patent application is a continuation-in-part of U.S. patent application Ser. No. 12/284,949 filed Sep. 25, 2008, which is a continuation-in-part of U.S. patent application Ser. No. 11/644,274 filed Dec. 22, 2006, which is a continuation-in-part of U.S. patent application Ser. No. 10/607,964 filed Jun. 27, 2003.

### STATEMENT REGARDING FEDERALLY SPONSORED RESEARCH

Not Applicable.

### BACKGROUND OF THE INVENTION

A. Field of the Invention

The field of the present invention relates generally to load support racks utilized for pickup trucks, SUVs and similarly configured vehicles. More particularly, the present invention relates to such racks that removably mount to the vehicle's bedrails or cargo rail without requiring drilling or other modifications to the vehicle and which are disassemblable for ease of installation, removal and shipping. Even more particularly, the present invention relates to such racks that have more than one horizontally disposed mounting crossbar to allow attachment of different types rack mounting accessories.

B. Background

As is generally known, many people utilize pickup trucks, SUVs and similarly configured vehicles for transporting work supplies, sporting equipment and other materials. Although pickup trucks generally have a rear cargo area bed that is suitable to carry a variety of materials, many people prefer to utilize a truck rack to carry some of these materials. The use of a truck rack provides additional carrying capacity for the pickup truck and frees up the rear cargo area to carry larger or heavier weight materials. With regard to carrying certain elongated or oversized materials, such as long ladders, canoes, pipes, lumber or metal, the use of an above-bed rack assembly is almost a necessity to prevent these materials from substantially extending beyond the rear of the vehicle or from being carried in an unbalanced condition. Most truck racks are configured to allow these longer materials to be carried in a manner that extends the materials over the cab portion of the pickup truck.

The prior art discloses a wide variety of truck racks suitable for use with pickup trucks and similar vehicles. The typical pickup truck configured rack comprises a plurality of interconnected frame members that form the frame portion of the rack. Some of the known truck racks utilize frame members that are fixedly connected to each other, such as by welding or riveting, while other racks have frame members that are connected with bolts, screws and other removable connectors. Most known truck racks mount to the pickup truck by mechanisms that require drilling, welding or other modifications to the horizontally displaced load bearing bed and/or the upstanding forward wall, sidewalls and/or rear tailgate portions of the rear cargo area. Other truck racks utilize various clamping mechanisms to clamp the frame to the pickup truck or utilize connectors that are received in one or more of the stake pockets that are commonly located on the sidewall bedrails (i.e., the generally shaped, upper most portion of the sidewalls). For the typical truck rack, at least a portion of the frame rests on and is supported by the pickup truck's bedrails. Unfortunately, the placement of frame members on the bedrail interferes with the mounting of tool boxes or other equipment on the bedrails. In addition, because the uppermost edge of many bedrails are not substantially horizontal, the truck rack frame is mounted on the bedrail at an undesirable angle, which can create load bearing and material carrying problems for the truck rack. As a result, in order to resist collapse of the rack and/or dislodging of the rack off the truck due to shearing loads, the typical bedrail mounted truck rack requires heavier weight frame members to provide the necessary support and to safely carry the desired loads. The heavier weight frame members generally require bulky and sophisticated mounting systems and result in a truck rack that is generally difficult for the user to install and remove and expensive for the manufacturer to ship.

A number of prior art patents describe different configurations for pickup truck racks that are adaptable for use to carry various materials, including elongated or oversized materials, above the bed of a pickup truck. For instance, the prior art includes truck racks that are bolted or otherwise attached to a pickup truck with one or more holes drilled in the pickup truck, as exemplified by U.S. Pat. No. 6,557,917 to Colcombe, U.S. Pat. No. 6,513,849 to Carter, U.S. Pat. No. D436,915 to Burger, U.S. Pat. No. 5,002,324 to Griffen and U.S. Pat. No. 4,676,543 to Lewis. The patents to Carter and Lewis also show that it is known to weld a part of the utility rack frame directly to the pickup truck. Each of these patents require modification to the pickup truck, a requirement that is unacceptable to many pickup truck owners. The prior art pickup truck racks that utilize one or more stake pockets either to receive part of a frame member into the stake pocket or utilize stake pocket anchors that connect to a frame member. These types of systems are exemplified by U.S. Pat. No. 6,347,731 to Burger, U.S. Pat. No. D444,446 to Carter, U.S. Pat. No. 5,806,905 to Moore, U.S. Pat. No. 5,692,791 to Sulzer, U.S. Pat. No. 5,190,337 to McDaniel, U.S. Pat. No. 4,659,131 to Plournoy, Jr., and U.S. Pat. No. 4,405,170 to Raya. Some of these patents, such as those to Sulzer and Raya, also disclose the use of bolts, with holes drilled into the truck, and clamps to further secure the frame to the truck bedrail. Other patents disclose truck racks that require at least one component to be mounted to the truck bed floor or the sidewall, such as U.S. Pat. No. 4,509,787 to Knaack et al., U.S. Pat. No. 4,138,046 to De Freze and U.S. Pat. No. 3,891,262 to Brunel. A few patents, such as U.S. Pat. No. 6,340,106 to Dutton (FIG. 7) and U.S. Pat. No. 5,628,540 to James, disclose the use of clamping members to clamp a portion of the pickup truck frame to the bedrail of the pickup truck.

Although the prior art discloses a number of truck racks for use with pickup trucks and the like, there are certain characteristics of these racks that have generally limited their complete acceptance. For instance, some of these utility racks are not adaptable to different sized rear cargo areas or, if adaptable, only adaptable in a very limited range of sizes. Those truck racks that fixedly mount to the pickup truck substantially reduce the flexibility of the truck owner for utilizing the rear cargo area for certain uses, such as carrying a camper shell or certain sized materials, that require at least temporary removal of the rack from the truck. In addition, the truck racks that have frame members fixedly attached to each other are generally not easy to install on or remove from the pickup truck and are very difficult to ship. Even some of the truck racks that are configured to be taken on and off the pickup truck are not necessarily easy to install or remove, generally due to the size and/or weight of the individual frame members. Those truck racks that rely on engagement with or otherwise use of one or more stake pockets are limited to those pickup trucks that have stake pockets and, when used, foreclose the ability of the pickup truck owner to utilize the stake pocket for other purposes.

As set forth above, many of the current methods of securing a truck rack to a pickup truck or other vehicle require the user to drill at least one hole, and typically a plurality of holes, in the truck for receiving a bolt or other connector to mount a portion of the rack to the truck. This approach to securing a utility rack to a pickup truck has several well known drawbacks, the primary ones being the effort required to drill holes, having holes in the vehicle and having a utility rack that, even if allegedly removable, is typically not easy to remove. As is also well known, holes drilled in a vehicle for a truck rack are not easily repaired when the owner no longer desires to use the truck rack with the vehicle or when the vehicle is to be offered for sale without the rack.

Sport utility vehicle (SUVs), vans and similarly configured vehicles, hereinafter such vehicles are collectively referred to as SUVs, have an enclosed rear cargo area that is suitable for carrying a wide variety of materials, including construction equipment and materials, camping/hiking gear, outdoor equipment and the like. To free up room inside the vehicle, however, many people prefer to utilize a rack on the roof of the SUV. With regard to carrying certain elongated or oversized materials, such as long ladders, canoes, kayaks, long pipes, lumber or metal posts, the use of an above-roof rack system is a necessity. Recognizing this need, most SUV manufacturers provide the SUV with a pair of spaced apart, parallel cargo rails that extend along a portion of the length of the SUVs roof, typically along a majority of the roof, to which one or more crossbars, typically two crossbars, are attached in spaced apart relation with their ends connected to the cargo rails. Although materials to be carried on the rack can be supported by and attached to the rack system provided by the SUV manufacturer, most people prefer to utilize an after-market rack system due to the increased load carrying capacity of such rack systems and the ability of these rack systems to utilize accessory attachments that are specially configured to better carry certain items. Because the rack systems are placed on the roof, they need to be lightweight in addition to being strong. The rack systems for SUVs have many of the same considerations with regard to having to assemble, disassemble, ship and store the rack as the truck racks described above.

The typical after-market rack system has two or more pairs of end pieces, commonly referred to as boots, that removably attach to the cargo rails provided by the SUV manufacturer to support a mounting crossbar across the width of the roof between each pair of boots. Typically, the carried materials are removably attached to and supported by the mounting crossbars. To improve the functionality of their rack systems, most after-market rack manufacturers provide a variety of specially configured accessory attachments that are mounted to the mounting crossbars and are designed to carry specific types of items, such as one or more bicycles, canoes or kayaks, snow boards, skis or a cargo carrier. Because these items are configured differently, the accessory attachments are also configured differently, generally in a somewhat corresponding configuration to the item to be carried. Because the cargo rails are different for different SUVs, the boots that attach to the cargo rails must be configured for a specific SUV or for a range of SUV models. In addition, because the width of the roof of many SUVs are different, the mounting crossbar must be provided in a width that is specific for a particular SUV model or, possibly, a range of SUV models. Some pickup trucks have similarly configured cargo rails on the roof of the vehicle's passenger compartment to provide additional carrying capacity for the vehicle. Accessory attachments are also generally available for these rack systems.

The rack system manufacturers generally manufacture their mounting crossbars with different cross-sectional shapes, which results in one manufacturer's accessory attachments being unable to be utilized with the rack system of a different rack system manufacturer. This requires the purchaser of a particular rack system to obtain any accessory attachments from the same company that sold the rack system. For instance, rack systems available from Thule, Inc. have a mounting crossbar with a rectangular cross-section and rack systems available from Yakima Products, Inc. have a mounting crossbar with a round cross-section. These two companies are the most commonly utilized rack systems for pickup trucks and SUVs.

The different sizes and shapes of cargo rails and the differently shaped mounting crossbars of the after-market rack systems results in a number of problems for the SUV or pickup truck owner. One problem is that a person who purchases a rack system for a particular vehicle must typically leave the rack system on the vehicle when he or she sells the vehicle because the rack system is unlikely to fit the person's next vehicle. In addition, unless the owner is sure that the next vehicle will have the same after-market rack system, the various accessory attachments that he or she has purchased or otherwise acquired are also transferred with the vehicle or sold separately. As well known, the cost of after-market rack systems and accessory attachments can be quite significant. Another problem is that once a SUV owner chooses a particular brand of after-market rack system, he or she is generally stuck with that system. This can be a problem when choosing accessory attachments for the rack system, as not all rack system manufacturers offer the same accessory attachments or quality of accessory attachments. For instance, one manufacturer may have a superior bike carrier, but the another manufacturer has a superior kayak carrier. With presently available rack systems, the SUV owner must choose a particular rack system manufacturer (assuming that his or her vehicle cargo rail configuration is available from more than one manufacturer) and stick with that brand no matter the availability or quality of the particular accessory items provided by that rack system manufacturer. The different configuration of the mounting crossbars of the rack systems make it impossible for one person to borrow another persons's accessory attachments for use with the rack system on their vehicle or to borrow another person's vehicle and utilize their accessory attachments with the borrowed vehicle's rack system unless the two vehicles have the same rack system. Another problem is that most currently available accessory attachments cannot be attached, or at least not easily attached, to presently available truck racks that are utilized with pickup trucks and the like, substantially limiting the ability of the pickup truck owner who has a truck rack from using the accessory attachments with his or her truck rack.

What is needed, therefore, is a rack suitable for use with pickup trucks and SUVs that is easily disassembable and relatively lightweight for ease of installation, removal, storage and shipping, but which is configured to carry the desired loads and items on the rack and which removably mounts to the pickup truck or SUV without requiring holes be drilled in or other modifications be made to the vehicle. Preferably, an improved rack system will be easily adaptable for use as a pickup truck rack for pickups having a relatively wide range of different sized rear cargo areas and as a roof rack for SUVs having a relatively wide range of different sized roof widths. In addition, it is preferred that the improved rack system be configured to allow use of accessory attachments from different manufacturers to allow the owner or user to select the most desirable accessory attachment independent of the manufacturer of the accessory attachment. For use as a truck rack, it is desirable that an improved pickup truck rack include a mounting system that quickly, easily and securely mounts the rack to the bedrails of a truck and be suitable for safe and effective use on a pickup with bedrails which are not horizontal relative to the truck bed. It is also desirable that the improved truck rack have a mounting system which does not interfere with the mounting of tool boxes and other equipment on the bedrails. For use as a roof rack, it is desirable that the improved rack be adaptable for attachment to a wide variety of different sizes and configurations of SUV or pickup truck cargo rails and be able to utilize a variety of accessory attachments that are available from after-market rack system manufacturers.

### SUMMARY OF THE INVENTION

The rack for pickup trucks and SUVs of the present invention solves the problems and provides the benefits identified above. That is to say, the present invention discloses a disassemblable rack which is relatively quick and easy to install on and remove from a pickup truck or SUV and relatively easy to store and ship but which is beneficially configured to carry the desired loads on the rack. The rack of the present invention is adaptable to a wide range of widths of truck beds so as to carry a load above the bed of the pickup truck and to a wide range of roof widths to carry a load on the roof of a SUV or pickup truck. In the preferred embodiment of the present invention, the rack has a mounting system that does not require any holes to be drilled in or other modifications be made to the pickup truck or SUV. The rack of the present invention comprises dual mounting crossbars that allow the user to select which mounting crossbar is utilized as the primary mounting crossbar so that he or she may attach and use the accessory attachment(s) of his or her choice. The rack is configured to allow the user to easily and quickly change which mounting crossbar is the primary mounting crossbar so that he or she may utilize different brands of accessory attachments. Use of the dual mounting crossbars frees the user to select the accessory attachment he or she desires independent of the brand of accessory attachment. In addition, the rack of the present invention is structurally stronger and more attractive than many currently available racks, particularly truck racks. The mounting system of the preferred embodiment of the rack of the present invention is configured for quick and easy installation on the bedrails of a pickup truck or the cargo rails on a SUV or pickup truck and for secure and safe installation thereon. The preferred mounting system of the present truck rack is suitable for use with pickup trucks that do not have stake pockets in the bedrail or, if they do, for owners who do not want to utilize the stake pockets for the truck rack. With regard to roof racks, the mounting system of the present invention can be utilized with a wide range of cargo rail configurations, which allows the user to easily move the rack from one vehicle to another.

In one aspect of the present invention, the rack generally comprises an elongated span member, a first rack assembly and a second rack assembly. When used as a truck rack, the first and second rack assemblies mount to the bedrails or accessory tracks on the opposing sidewalls of a pickup truck to transversely dispose the span member above the bed of the pickup truck. When used as a roof rack, the first and second rack assemblies mount to the spaced apart cargo rails on the roof of a SUV or pickup truck to transversely dispose the span member above the roof of the vehicle. Although the first and second rack assemblies can be fixedly attached to the bedrails, accessory tracks or cargo rails, typically requiring holes to be drilled into these components, in the preferred embodiment of the present invention the first and second rack assemblies removably attach to the bedrails, accessory tracks or cargo rails of the vehicle. Likewise, although the first and second rack assemblies can fixedly attach to the span member, in the preferred embodiment the rack assemblies removably attach to the span member. In the preferred configuration, the rack is easily assembled on the vehicle when needed to carry cargo and removed therefrom when no longer needed. In addition, the rack can be disassembled into a relatively small package for ease of handling, shipping and storage.

In describing the present invention with a vehicle, the bed or roof of the vehicle is referred to as the rack support surface and the bedrails, accessory tracks and cargo rails are referred to as the first and second rack mounts, which are disposed in spaced apart relation. Preferably, the elongated span member has a first end and a second end and comprises a first mounting crossbar, a second mounting crossbar and one or more crossbar spacing members that are disposed between and interconnect the first and second mounting crossbars to maintain the mounting crossbars in spaced apart relation. The first mounting crossbar has a first cross-section, meaning the size and shape of the crossbar, and the second mounting crossbar has a second cross-section. Although the two cross-sections can be the same, in the preferred embodiment of the rack of the present invention the first and second cross-sections are in contrasting relation to each other, meaning their cross-sections are different sizes and/or shapes so that they can be utilized to mount different types of accessory attachments, such as those used to support a canoe, kayak, snow board, pair of skis, bicycle or other types of specific cargo.

In the preferred embodiment of the rack of the present invention, each of the first and second rack assemblies has a leg member, a clamping assembly at or near the lower end of the leg member and a span clamp assembly at the upper end of the leg member. The preferred clamping assembly has a base member configured to clamp the lower end of the leg member of the first rack assembly to the first rack mount and the leg member of the second rack assembly to the second rack mount. The preferred span clamp assembly has a grip plate that is configured to clamp the upper end of the leg member of the first rack assembly to the first end of the span member and the upper end of the leg member of the second rack assembly to the second end of the span member. In the preferred embodiment, each of the grip plates has an angled upper section and an angled lower section, with the upper section being configured to engage the upper crossbar (either the first mounting crossbar or the second mounting crossbar) and the lower section being configured to engage the other mounting crossbar, which is disposed below the upper crossbar. For the truck rack embodiment, each of the span clamp assemblies has a leg engaging plate that is affixed to the back of the grip plate that is placed in abutting relation to the upper ends of the leg members when the grip plate is clamped against the span member to provide additional shearing resistance for the rack.

The first rack assembly and the second rack assembly cooperatively support the span member above the bed, roof or other rack support surface with the span member disposed generally transversely across the rack support surface. In the preferred embodiment, either the first mounting crossbar or the second mounting crossbar is disposed generally vertically above the other mounting crossbar, depending which of the two mounting crossbars is desired to be utilized to mount accessory attachments. If desired or necessary, the user can disconnect the span clamp assemblies to separate the span member from the first and second rack assemblies, flip the span member over and remount the span member to the first and second rack assemblies with a different mounting crossbar on top so that it is available for attachment of one or more accessory attachments.

In one embodiment, the rack is used as truck rack with the first rack mount being a bedrail disposed on one of the sidewalls and the second rack mount being the bedrail disposed on the opposing sidewall. Each of the clamping assemblies comprise an upper clamp assembly and a lower clamp assembly, with the upper clamp assembly having a channel member attached to or integral with the base member and the lower clamp assembly having upwardly disposed engaging and insert members. The preferred engaging member has an upper end configured to engage the underside surface of the bedrail and the insert member is sized and configured to be received in an insert channel defined by the channel member. The insert member is secured to the channel member with an engaging means that interconnects the channel member and the insert member to secure the rack to the vehicle.

In another embodiment, the rack is used as a truck rack with the first rack mount being an accessory track disposed on one of the sidewalls and the second rack mount being an accessory track disposed on the opposing sidewall.

Each clamping assembly comprises an upper clamp assembly and a lower clamp assembly, with the upper clamp assembly having a channel member attached to or integral with the base member and the lower clamp assembly having an insert member that is sized and configured to be received in an insert channel defined by the channel member. The insert member is secured to the channel member with an engaging means that interconnects the channel member and the insert member to secure the rack to the vehicle.

In yet another embodiment, the rack of the present invention is used as a roof rack where the rack support surface is the roof of the vehicle and each of the first and second rack mounts are cargo rails on the roof. The clamping assembly of the first rack assembly is configured to clamp the first rack assembly to one of the cargo rails and the clamping assembly of the second rack assembly is configured to clamp the second rack assembly to the opposing cargo rail to dispose the span member transversely across and above the roof of the vehicle. Each clamping assembly has a downwardly projecting section on the base member that is configured to abut an edge of the cargo rail, a lower clamp member configured to engage the underside surface of the cargo rail and an engaging means that interconnects the base member and the lower clamp member to engage the cargo rail between the base member and the lower clamp member to secure the rack to the cargo rails.

Accordingly, the primary objective of the present invention is to provide an improved rack for pickup trucks and SUVs that provides the advantages discussed above and that overcomes the disadvantages and limitations of presently available racks for pickup trucks and SUVs.

It is also an important objective of the present invention to provide a rack for pickup trucks and SUVs that has a horizontal span member, which is supported above the bed of a pickup truck or the roof of a SUV, that has dual mounting crossbars for attachment to different models of accessory attachments.

It is also an important objective of the present invention to provide a rack that is easily installed on and removed from pickup trucks having a bed with a peripherally disposed sidewall without requiring drilling into the sidewall or making other modifications to the pickup truck.

It is also an important objective of the present invention to provide a rack that is easily installed on and removed from the cargo rails on the roof of a SUV or pickup truck passenger compartment without requiring drilling holes into the vehicle or making other modifications to the vehicle or cargo rails.

It is also an important objective of the present invention to provide a rack for pickup trucks and SUVs that is adaptable to a wide range of pickup truck cargo widths and a wide range of SUV or pickup truck roof widths to allow the same rack to be utilized on different vehicles.

It is also an important objective of the present invention to provide a rack for pickup trucks and SUVs that can be quickly and easily disassembled for ease of installing, removing, storing and shipping the rack.

It is also an important objective of the present invention to provide a rack for pickup trucks that removably attaches to the bedrail of the truck without using any stake pockets in the bedrail and which allows continued utilization of the bedrail to support tool boxes and other equipment.

It is also an important objective of the present invention to provide a rack for pickup trucks and SUVs that is configured to carry the desired loads and resist the load and shear forces from those loads while utilizing relatively lightweight materials for the rack components.

It is also an important objective of the present invention to provide a rack for pickup trucks and SUVs that can utilize a variety of different clamping systems to removably clamp a base member of the rack onto the bedrail of a pickup truck or the cargo rail of a SUV or pickup truck.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a top plan view of a pickup truck having a pair of truck racks that are configured according to one embodiment of the present invention;

FIG. 2 is a rear view from behind the first or forwardly disposed truck rack shown in FIG. 1 showing the truck rack mounted on the bedrails of a pickup truck above a plane disposed between the bedrails and the bed of the rear cargo area;

FIG. 3 is an exploded rear view of the truck rack shown in FIG. 2;

FIG. 4 is a rear view of the left or first span member, gusset and engaging member of the first rack assembly of the truck rack shown in FIG. 3;

FIG. 5 is a rear view of the right or second span member, gusset and engaging member of the second rack assembly of the truck rack shown in FIG. 3;

FIG. 6 is an isolated side view of the first support member and the clamping mechanism of the first rack assembly shown in FIG. 3;

FIG. 7 is an isolated rear view of the second support member and the clamping mechanism of the first rack assembly shown in FIG. 3;

FIG. 8 is a side view of the lower clamp assembly of the clamping mechanism utilized with the truck rack shown in FIGS. 2 and 3;

FIG. 9 is a rear view of the lower clamp assembly shown in FIG. 8;

FIG. 10 is a top view of the lower clamp assembly shown in FIG. 8;

FIG. 11 is an isolated rear view of the lower end of the first rack assembly of the truck rack mounted on the truck showing the clamping mechanism engaged with the bedrail of the truck;

FIG. 12 is a top view of base member utilized with the clamping mechanism of FIG. 11;

FIG. 13 is a top view of an alternative embodiment of the base member showing the channel member having an upper wall with a pair of apertures therein;

FIG. 14 is an isolated rear view of the upper end of an alternative embodiment of the first rack assembly showing use of a spacer member disposed between the upper end of the leg and the first span member;

FIG. 15 is an exploded view of the upper end of the first rack assembly of FIG. 14;

FIG. 16 is an isolated view of the first end of the first span member of FIG. 4 showing the connecting mechanism utilized to connect the first span member and second span member together;

FIG. 17 is a bottom view of the connecting plate of the connecting mechanism shown in FIG. 16;

FIG. 18 is a rear view of an alternative embodiment for a truck rack showing use of a tubular engaging member having the upper end of the leg member received therein;

FIG. 19 is a rear view of the first truck rack shown in FIG. 2 showing an alternative embodiment of the clamping mechanism for use with pickup trucks having an accessory track on the bedrail of the truck;

FIG. 20 is an isolated view of the clamping mechanism of FIG. 19;

FIG. 21 is an alternative embodiment of the clamping mechanism configured for use with pickup trucks having an accessory track on the bedrail;

FIG. 22 is a side view of an insert plate utilized with the clamping mechanisms of FIGS. 20 and 21;

FIG. 23 is a rear view of an alternative embodiment of the first truck rack shown utilizing the clamping mechanism of FIG. 2;

FIG. 24 is an isolated exploded rear view of the second span member and second support member of the first truck rack shown in FIG. 23;

FIG. 25 is side view of a vehicle having racks configured according to the preferred embodiment of the present invention, showing two racks configured as truck racks, with one mounted on a bedrail and the other mounted on an accessory track, and one rack configured as a roof rack mounted on a cargo rail on the roof of the vehicle;

FIG. 26 is rear view of the truck rack embodiment of FIG. 25 shown mounted on a pickup truck with the span member shown in its lower position;

FIG. 27 is a rear view of the truck rack embodiment of FIG. 26 with the span member shown in its upper position;

FIG. 28 is an exploded rear view of the truck rack embodiment of the rack of the present invention showing both the bedrail and accessory track components;

FIG. 29 is a side view of the span member taken through 29-29 of FIG. 28 showing the use of mounting crossbars with different cross-sections;

FIG. 30 is a rear view of the leg member and clamping assembly shown separated from each other to illustrate the use of the tube engaging member;

FIG. 31 is a side view of the clamping assembly utilized with the embodiment of the present invention configured for clamping the rack assemblies to the bedrail of a pickup truck;

FIG. 32 is a rear view of the L-shaped brace member and the engaging member utilized with the clamping assembly of FIG. 31;

FIG. 33 is a side view of a rack assembly and attached span member for use with the truck rack embodiment to clamp the rack assembly to an accessory track of a pickup truck;

FIG. 34 is an exploded view of the rack assembly and span member of FIG. 33;

FIG. 35 is a side view of a vehicle showing use of a pair of racks of the present invention configured as roof racks and clamped to the cargo rack on the roof of the vehicle;

FIG. 36 is a back view of one of the roof racks of FIG. 35 shown clamped to the cargo rail of the vehicle;

FIG. 37 is an exploded back view of the roof rack of FIG. 36;

FIG. 38 is a top view of the upper clamp assembly and leg member utilized with the rack of FIG. 36; and

FIG. 39 is a top view of the lower clamp assembly utilized with the rack of FIG. 36.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain configurations for the components of the rack and clamping mechanism to clamp the rack to the sidewalls of a pickup truck or the cargo rails of a SUV or pickup truck, those skilled in the art will readily understand that this is merely for purposes of simplifying the present disclosure and that the present invention is not so limited.

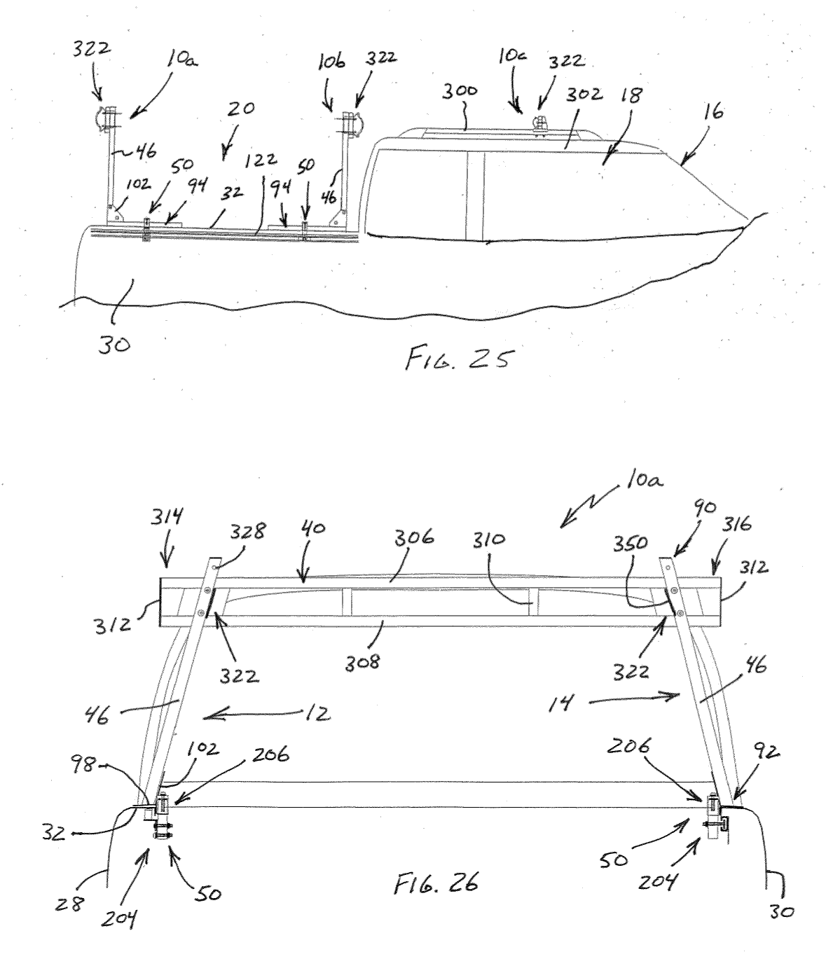

A rack for use on trucks and SUVs that is manufactured out of the various components and configured pursuant to one embodiment of the present invention is shown as 10 in FIGS. 1 through 3, 14, 19, 23, 25 and 35. As best shown in FIGS. 1 and 25, the rack 10 of the present invention can be configured as a truck rack that is utilized with a pickup truck 16. Rack 10 is typically utilized as a pair to form a truck rack system having a first or forwardly disposed rack 10a and a second or rearwardly disposed rack 10b. Typically, racks 10a and 10b will be identically configured as rack 10 and, for purposes of the present disclosure, the first rack 10a and second rack 10b are also both generally referred to herein as truck rack 10. As known to those skilled in the art, however, in some rack system configurations a person will utilize a different rack in place of either the first 10a or the second 10b rack to cooperate with the remaining rack 10a or 10b. As shown in FIGS. 1 and 2, in one embodiment truck rack 10 generally comprises a first rack assembly 12 and a second rack assembly 14 on the opposite sides of truck 16 having a cab portion 18 and a rear cargo area 20 located rearward of cab portion 18. The rear cargo area 20 has a generally horizontal load bearing bed 22 that is bounded on its periphery by upstanding forward wall 24, tailgate 26 and a pair of opposing sidewalls 28 and 30. Each of sidewalls 28 and 30 has a bedrail 32 at the top thereof that comprises, as best shown in FIG. 11, a generally planar top surface 34 and an inwardly disposed lip 36. The typical bedrail 32 has one or more stake pockets 38 located thereon. As best shown in FIGS. 1, 2 and 25, first truck rack 10a and second truck rack 10b are positioned on bedrail 32 in spaced apart relationship to each other to support a load, such as ladders, pipe, lumber, canoes and other cargo (not shown), generally above the rear cargo area 20 and cab 18. As will be readily understood by those skilled in the art, first rack 10a and second rack 10b can be moved anywhere along bedrail 32 to change the spacing therebetween and as well as the spacing between first rack 10a and cab 18 and between second rack 10b and tailgate 26 (the rearward end of truck 16) where necessary and/or convenient for the racks 10a/10b to be located so as to best support the desired cargo on truck 16.

In the various embodiments shown in the figures, the truck rack 10 generally comprises a first rack assembly 12 and a second rack assembly 14 that cooperatively join together, as set forth below, to define a single rack 10 with an interconnected span member 40 that is supported above the bed 22 of the truck 16 in a generally transverse relationship to the bed 22 by the components of the first 12 and second 14 rack assemblies, as best shown in FIG. 2. The first rack assembly 12 and second rack assembly 14 of racks 10a/10b are mounted to the bedrail 32 of the opposing sidewalls 28 and 30. In the embodiment of FIGS. 1 and 2, first rack assembly 12 comprises an elongated first span member 42, an engaging member 44 projecting generally downwardly from first span member 42, a leg member 46 engaged with the engaging member 44, a gusset member 48 interconnecting the first span member 42, the engaging member 44 and the leg member 46, and a clamping assembly 50 configured to demountably secure leg member 46 to the bedrail 32 of one of the pair of opposing sidewalls, such as first sidewall 28. The first span member 42, best shown in FIGS. 2 through 4, has a first end 52 that is disposed generally above the bedrail 32 of first sidewall 28 and a second end 54 that extends in a direction generally inward from the first sidewall 28 above the bed 22 when truck rack 10 is installed on the truck 16.

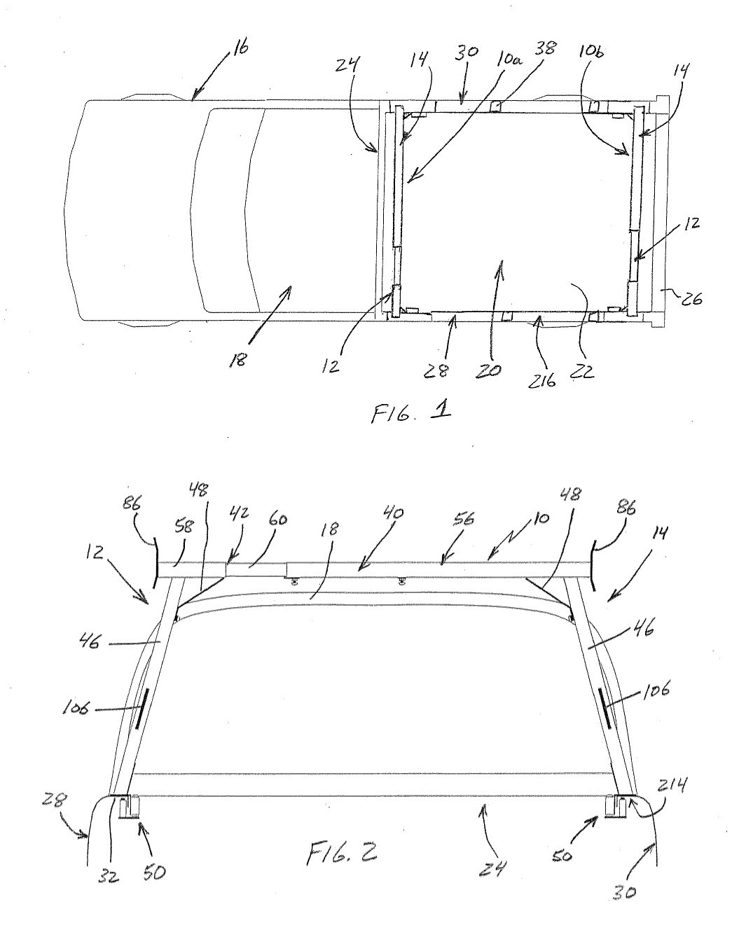

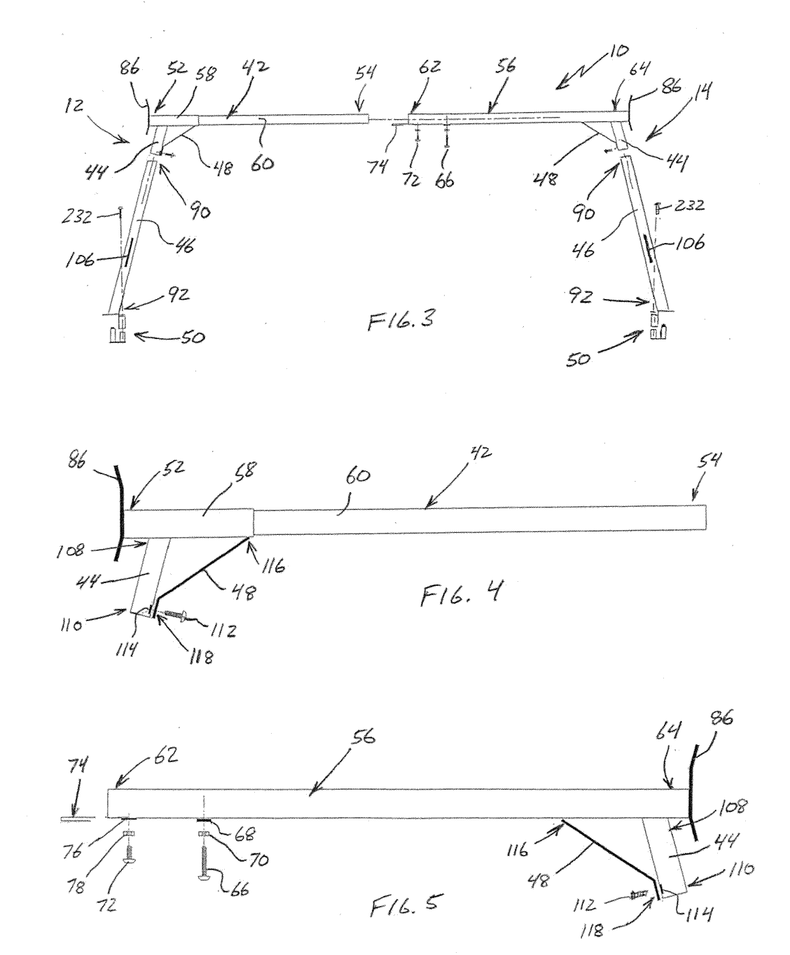

Although truck rack 10 can be configured with a particular, fixed length of interconnected span member 40 to fit a specific width of bed 22, the embodiment of FIGS. 1 and 2 has the interconnected member 40 configured to be longitudinally adjustable in length so that a single truck rack 10 may be utilized on a variety of different sized pickup trucks 16 having different widths of bed 22 and so that the truck rack 10 may be easily disassembled for ease of installation, removal, storage and shipping. In this embodiment, the interconnected span member 40 comprises the first span member 42 and a second span member 56, which is a component of the second rack assembly 14, that cooperate together in a telescoping manner to allow the user to lengthen or shorten the length of interconnected span member 40 to fit different sizes of bed 22. To accomplish the above, the second span member 56 is tubular so that a portion of the first span member 42 is received therein. As best shown in FIG. 4, first span member 42 has a first section 58 generally toward the its first end 52 and a second section 60 generally toward its second end 54, with the second section 54 being sized and configured so that it may be received through the first end 62 of second span member 56 at least enough of a distance to sufficiently interconnect the first 42 and second 56 span members. In a preferred configuration, first span member 42 is a generally square tube with the second section 60 thereof sized and configured to have a smaller cross-section size than the first section 58 thereof and the second span member 56, which is preferably the same size and configuration as first section 58, so that second end 54 and a sufficient amount of second section 60 of first span member 42 are insertably received in the first end 62 of second span member 56, which is also a generally square tube (although other shapes can be utilized for first span member 42 and second span member 56). Different lengths of interconnected span member 40 for different sized rear cargo areas 20 can be achieved by sliding the second section 60 of the first span member 42 in and out of the second span member 56. If desired, first 42 and second 56 span members can be sized such that the second section 60 of first span member 42 extends inside second span member 56 substantially the entire distance toward second end 64 of second span member 56 when utilized on a small pickup truck 16.

As stated above, in the preferred embodiment both first section 58 and second section 60 of first span member 42 are elongated tubes, with one end of the second section 60 inserted into the adjoining end of the first section 58 and the two pieces welded or otherwise joined together to form a substantially integral first span member 42 from first end 52 to the second end 54 thereof. The second span member 56 is also a tube, having an open first end 62 that is sized and configured to receive the second section 60 of first span member 42 therein to provide the desired telescoping feature. Both first 42 and second 56 span members should be sized and configured to support the desired loads on the truck rack 10 of the present invention. In the preferred embodiment, however, the first 42 and second 56 span members are also selected such that a single person can install and remove truck rack 10 and it may be shipped to the buyer for a reasonable shipping cost.

As known in the art, one or more span connectors, such as a set screw or the like, is utilized to lock first span member 42 to second span member 56 so as to fix the length of interconnected span member 40 for the width of the bed 22, between sidewalls 28 and 30, for the particular truck 16 on which truck rack 10 will be utilized. The use of a set screw, such as set screw 66 in FIG. 5, or the like for a span connector prevents movement of first span member 42 relative to second span member 56 and, as such, reduces vibration of truck rack 10. In one embodiment, a hole is provide in one of the sides of second span member 56 at a position generally towards its first end 62 for set screw 66 to be threadably received through the hole and against the outer surface of second section 60 of first span member 42 such that when the set screw 66 is threaded therein it will push against the outer surface of second section 60 to hold span members 42/56 together. In the preferred embodiment, however, weld nut 68 is fixedly attached to the outer surface of the second span member 56 at the location of the hole and jamb nut 70 is also utilized, with the set screw 66 being sufficiently long to extend through a hole drilled in a wall of second section 60 and abut the inner surface of the opposite wall of second section 60. In this manner, the distal end of the screw 66 will press against the inner surface of the second section 60 to press the outer wall of second section 60 against the inner wall of the second span member 56, thereby holding the first 42 and second 56 span members together without damaging the outer surface of second section 60 of first span member 42 so that it can be moved from one truck 16 to another without the damage, other than the hole, that would otherwise be apparent on the outer surface of second section 60 if the set screw 66 were to abut the outer surface of second section 60. The hole in the second section 60 for receiving the set screw 66 will be located at a position where the interconnected span member 40 is at the proper length for bed 22. Typically, this hole will be drilled by the user of truck rack 10 so that he or she can configure truck rack 10 for his or her truck 16. Alternatively, although likely more difficult with regard to the location, the hole can be pre-drilled by the manufacturer of truck rack 10 for a particular truck 16.

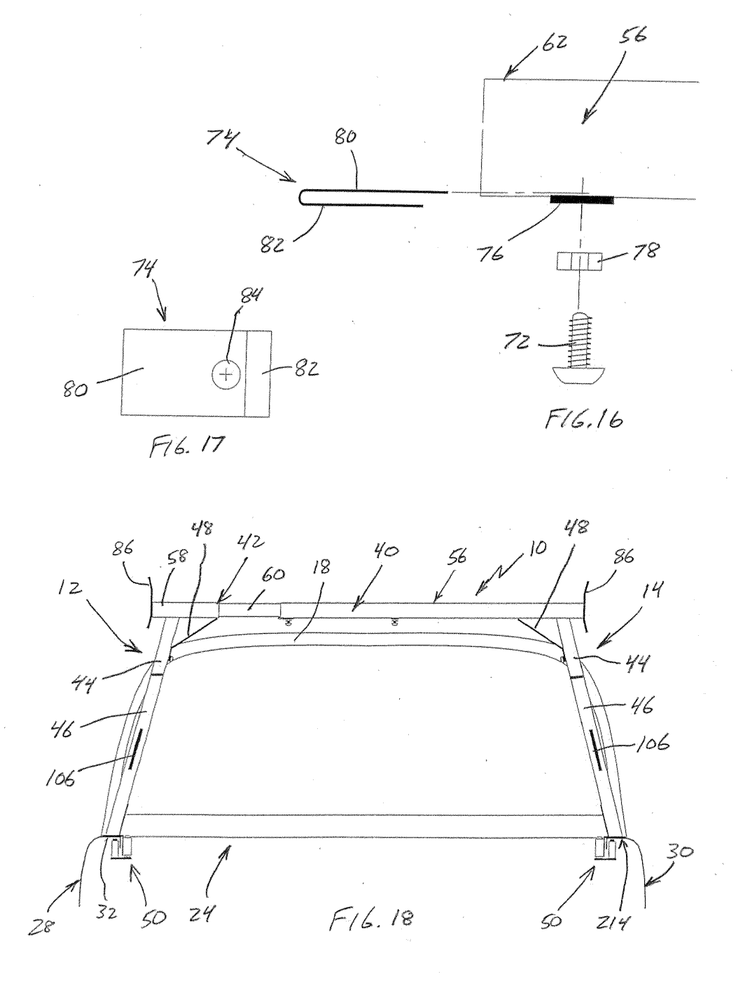

The embodiment of truck rack 10 of FIGS. 1 and 2, also includes a second span connecting mechanism, best shown in FIGS. 5, 16 and 17, for securely connecting first 42 and second 56 span members together to form interconnected span member 40. As with the above, a hole is provided in second span member 56 for a set screw, shown as 72. Preferably, the hole for this set screw 72 is provided somewhat closer to the first end 62 of second span member 56, as shown, and a connecting plate 74 is utilized, as well as weld nut 76 and jamb nut 78 (as described above), to clamp the two span members 42/56 together in a manner that does not damage the exterior surface of the second section 60 of the first span member 42. As best shown in FIGS. 16 and 17, connecting plate 74 has a generally U-shaped configuration with a first plate section 80 that is sized and configured to slide into the open first end 62 of second span member 56 and a second plate section 82 that extends on the exterior of the first end 62 of second span member 56. An aperture 84 in the second plate section 82 is configured to be aligned with the hole through which set screw 72 is received. Connecting plate 74 is placed inside the open first end 62 of second span member 56 with the loop interconnecting the first 80 and second 82 plate sections in abutting relation to the end of first end 62 to place aperture 84 over the hole in the second span member 56. When the set screw 72 is threaded through the jamb nut 78 and weld nut 76, it will pass through aperture 84 and press against the first plate section 80, which will be pressed against the exterior surface of second section 60 of first span member 42 without damaging the surface thereof. This will cause the second section 60 of first span member 42 to press against the interior surface of second span member 56, thereby securely connecting the first 42 and second 56 span members together to form the interconnected span member 40 of the size needed for the bed 22 of truck 16.

As noted above and set forth in more detail below, except for the various components of the span members 42/56 and the interconnected span member 40 the components of the first rack assembly 12 and the second rack assembly 14 are the same. The use of the same components, such as engaging members 44, leg members 46, gusset members 48 and clamping assemblies 50, provide interchangeability between the two rack assemblies 12/14 and reduces the cost of manufacturing and reduces the amount inventory that must be kept by a supplier or distributor. Because the components of the assemblies 12/14 are the same, unless otherwise noted, the same numeral designations are utilized for these components to simplify the understanding of the present disclosure.

As stated above, in the preferred embodiment both the first 42 and second 56 span members are tubular for their entire lengths. To close the open ends of the tube, at first end 52 of first span member 42 and at second end 64 of second span member 56 (which are the opposing ends of the interconnected span member 40), the preferred embodiment of truck rack 10 utilizes an ear member 86, best shown in FIGS. 4 and 5, to close the openings and provide certain other benefits for truck rack 10. The ear member 86 can comprise a generally flat, vertically disposed bar that is welded or otherwise fixedly attached to the ends 52 and 64 to close the tubular openings. In a preferred configuration, the ear member 86 projects above the top surface of the interconnected span member 40 to help prevent cargo from falling off of the sides of the truck rack 10 and projects below the bottom surface of the interconnected span member 40 to form a metal loop that can act as an anchor point for hooks or ropes that are used to secure the cargo on truck rack 10. If an ear member 86 is not needed to secure the cargo and provide an anchor point, such as in the embodiment of FIGS. 23 and 24, then a cap, such as the threaded cap member 88, or the like can be utilized instead.

To support the interconnected span member 40 in a generally horizontal position above the bed 22 of truck 16 and to connect to the bedrail 32 of truck 16, the truck rack 10 utilizes a leg member 46 at each of the first rack assembly 12 and second rack assembly 14. As best shown in FIGS. 2 and 3, the leg member 46 of first rack assembly 12 supports first span member 42 and the leg member 46 of second rack assembly 14 supports second span member 56. In the preferred embodiment, leg member 46 is a tube having an open upper end 90 that engages engaging member 44, as set forth in more detail below, and a lower end 92 that attaches to a base member 94 that is configured to abut bedrail 32 to support leg 46 on the sidewalls 28 and 30. To facilitate secure connection of the leg member 46 to the engaging member 48, an aperture 96 is provided in leg member 46 near the upper end 90 thereof. In the preferred embodiment, the base member 94 has a substantially horizontal section 98 that is configured to abut the top surface of the bedrail 32 and a generally vertical section 100 that is configured to abut the inside lip 36 of bedrail 32 when supported by sidewalls 28 and 30, as best shown in FIGS. 6, 7 and 11. As set forth in more detail below, clamping assembly 50 is configured to cooperatively engage the base member 94 to securely attach the truck rack 10 to truck 16 during use of rack 10. In the preferred embodiment, the lower end 92 of leg member 46 fixedly attaches to the base member 94 with support plate 102, which is attached by welding or other means appropriate for the materials utilized, that interconnects the leg member 46 and base member 94. If desired, one or more apertures 104 can be provided in support plate 102 for use to engage hooks, ropes or other cargo supporting devices. In an alternative embodiment, leg member 46 can pivotally attach to one end of the base member 94 so leg member 46 may be folded onto base member 94 for ease of handling, storing and shipping. With leg member 46 substantially folded onto base member 94, the various components of truck rack 10 can fit into a relatively narrow and easy to handle box that reduces shipping costs by fitting within certain size guidelines that have been established by shipping companies. Preferably, leg member 46 also includes one or more tie-down cleats 106, shown in FIGS. 2-3 and 6-7, that are welded or otherwise securely attached to one or more sides of leg member 46, such as the inwardly facing side of leg member 42 shown in the figures, and utilized for looping ropes or other cargo-securing mechanisms.

In one embodiment of the present invention, the leg members 46 are substantially vertical or angled outwardly from side walls 28/30. In the preferred embodiment of truck rack 10 of the present invention, however, the leg members 46 of both the first 12 and second 14 rack assemblies incline inwardly, relative to the generally vertical sidewalls 28 and 30, such that leg members 46 are angled toward each other, as shown in FIGS. 2, 3 and 7, in order to more effectively resist right-to-left horizontal movement (shearing strain). As best shown in FIG. 3, the engaging members 44 extending downwardly from the bottom sides of the first 42 and second 56 span members are cooperatively inclined with the leg members 46 so as to engage the upper ends 90 of the respective leg members 46. In one embodiment, leg members 42 are inclined inwardly approximately fifteen degrees from vertical and engaging members 44 are inclined outwardly approximately fifteen degrees from vertical. As stated above, in the preferred embodiment leg member 42 is tube, or at least the upper end 90 thereof is tubular, to receive its respective engaging member 44 therein.

As best shown in FIGS. 3 through 5, an engaging member 44 extends downwardly from the bottom side of each of the first 42 and second 56 span members. As set forth above, although the engaging members 44 can be configured to extend substantially vertically or inwardly from the span members 42/56, in the preferred embodiment engaging members 44 are inclined outwardly, relative to the substantially vertical sidewalls 28/30, in an angled amount that corresponds to the inwardly angled leg members 42. As also stated above, in the preferred embodiment of truck rack 10, the engaging members 44 are tubular and appropriately sized and configured to be received inside the tubular upper end 90 of leg member 42. Preferably, the upper end 108 of each engaging member 44 is fixedly attached to the bottom side of their respective span member 42/56. With regard to the first span member 42, the upper end 108 of the engaging member 44 is fixedly attached to the first section 58 thereof, as best shown in FIGS. 3 and 4, so as to not interfere with the movement of the second section 60 in and out of the first end 62 of second span member 56. A hole is provided near the lower end 110 of each of the engaging members 44 that is in alignment with aperture 96 near the upper end 90 of the leg members 42 so a connecting element, such as screw 112, can be received therein to secure the engaging member 44 to the upper end 90 of leg members 42. To facilitate the connection, a nut 114 or other connecting element is secured to the inside of engaging member 44 at the hole to threadably receive the screw 112. Various other connecting mechanisms can be utilized to connect each leg member 42 to its respective engaging member 44. Preferably, the components are configured such that the upper end 90 of leg member 42 abuts against the bottom side of their respective span members 42/56, as shown in the FIG. 2.

In an alternative embodiment, shown in FIGS. 14 and 15, the truck rack 10 is configured so the user can quickly and easily adjust the height of interconnected span member 40 without legs 46 being telescoping. As shown in these figures, truck rack 10 includes a spacer member 115 that is configured with the same cross-section as legs 46, but having a typical length of only two to six inches (although shorter or longer lengths can be utilized), to fit between the upper end 90 of leg member 46 and the bottom surface of first 42 or second 56 span members (the first section 58 of first span member 42 shown in the figures). To provide the option of using the spacer member 115, leg member 46 must be provided with or modified to include one or more additional apertures 96 to receive the screw 112 that is utilized to attach the gusset member 48 to the leg member 46 and engaging member 44. In use, the user slides spacer member 115 over engaging member 44, slides upper end 90 of the leg member 46 over engaging member 44 to push spacer member 115 up against the applicable span member 42 or 56, and then attaches the gusset member 48 to leg member 46 and engaging member 44 using screw 112 or other connecting mechanism (as appropriate).

In another alternative embodiment, shown in FIG. 18, the tubular engaging members 44 are cooperatively configured with the upper end 90 of leg members 42 such that the upper end 90 of each leg member 42 is received inside the tubular engaging member 44 (instead of over it, as described above). As with the preferred embodiment, one or more connecting mechanisms are utilized to securely, but removably, attach engaging members 44 to their respective leg member 42. In general, it is believed that most users will not find this configurations as attractive as the preferred embodiment.

As set forth above, truck rack 10 includes a gusset member 48 at each of the first 12 and second 14 rack assemblies, as best shown in FIGS. 2 through 5. As shown in these figures, a gusset 48 extends generally downward from each of the first span member 42 and the second span member 56 to their respective leg members 46 so as to interconnect the span members 42/56, leg member 46 and engaging member 44. The purpose of the gusset 48 is to further brace and strengthen the legs 46 and, for a certain strength level, allow lower weight and smaller size components, particularly the first 42 and second 56 span members and leg members 46. In a preferred embodiment, gusset 48 is a generally flat bar that has an upper end 116 which is welded or otherwise fixedly attached to the bottom of the respective first 42 or second 56 span members and a lower end 118 that has a shaped section 120 which is removably attached to the leg member 46 and its associated engaging member 44 with the screw 112, which engages nut 114 inside the engaging member 44. A hole or slot, not shown, in the shaped section 120 is positioned to align with the aperture 96 in leg member 46 and the hole, shown by the nut 114, in engaging member 44. When not connected, the lower end 118 of gusset 48 is in spaced apart relation to the lower end 110 of engaging member 44 so the upper end 90 of leg member 46 can slide between shaped section 120 and the outer surface of gusset 48, as best shown in FIGS. 4 and 5. Typically, this gap only needs to be approximately 0.10 of an inch, depending on the thickness of the wall of the tubular leg member 46. With regard to first span member 42, the upper end 116 of gusset 48 is preferably attached to the first section 58 of first span member 42 (as shown). Preferably, shaped section 120 is configured to be generally parallel to the sides of the engaging member 44 so that it will closely abut the outer surface of leg member 46 when attached with screw 112. In the preferred embodiment, shown in the figures, a single screw 112 is utilized to interconnect the engaging member 44, leg 46 and gusset 48 (and by connection, the span members 42/56), thereby simplifying the installation and removal of truck rack 10 from truck 16. In an alternative embodiment, the upper end 116 of gusset 48 can also be removably attached to the bottom side of the first 42 and second 56 span members utilizing a configuration and connecting elements similar to that used for the lower end 118 of gusset 48.

Various materials and component connection mechanisms can be utilized for the components of truck rack 10. For instance, first 42 and second 56 span members, engaging member 44, leg member 46 and gusset member 48 can be made out of metal, fiberglass, composites, certain plastics and various other materials and various combinations of such materials that have sufficient strength, rigidity, durability and corrosion resistance for truck rack 10 of the present invention. If desired, coated or covered materials can be used to provide the necessary corrosion resistance for its intended use of being exposed to the outside elements. It is necessary that the materials for the above components be selected so as to be sufficiently strong to support the cargo that is desired to be transported on truck rack 10. Likewise, the components and materials selected for clamping assembly 50 must be of sufficient strength, durability and corrosion resistance to provide sufficient clamping force to hold the truck rack 10 on the truck 16 even when fully loaded with cargo. In a preferred embodiment, the primary components for truck rack 10 are made out of metal, such as powder coated steel, stainless steel or aluminum.

As set forth above, a clamping assembly 50 is utilized to securely but removably clamp the truck rack 10 of the present invention to the bedrail 32 of the truck 16. In a preferred embodiment, the clamping assembly 50 is the clamp for truck racks that is disclosed in U.S. patent application Ser. No. 11/644,274, filed by the same inventor on Dec. 22, 2006, the disclosure of which is incorporated in its entirety herein as though fully set forth in the present disclosure. The clamp disclosed in the referenced patent application is configured for use with any type of truck rack that has a base member or like component which extends along a portion of the bedrail 32. The clamp of the above-referenced patent application is a separate component that removably clamps the base member of the rack to the bedrail of a truck. With regard to the present invention, a portion of the clamp disclosed in the above-referenced patent application, primarily the upper clamp assembly, is configured to be integral with the base member 94 of the truck rack 10. Except for the clamping assembly numeral itself, which is 50 herein, the numerals for the clamping assembly 50 are the same, for the same components, as those utilized in the above-referenced patent application.

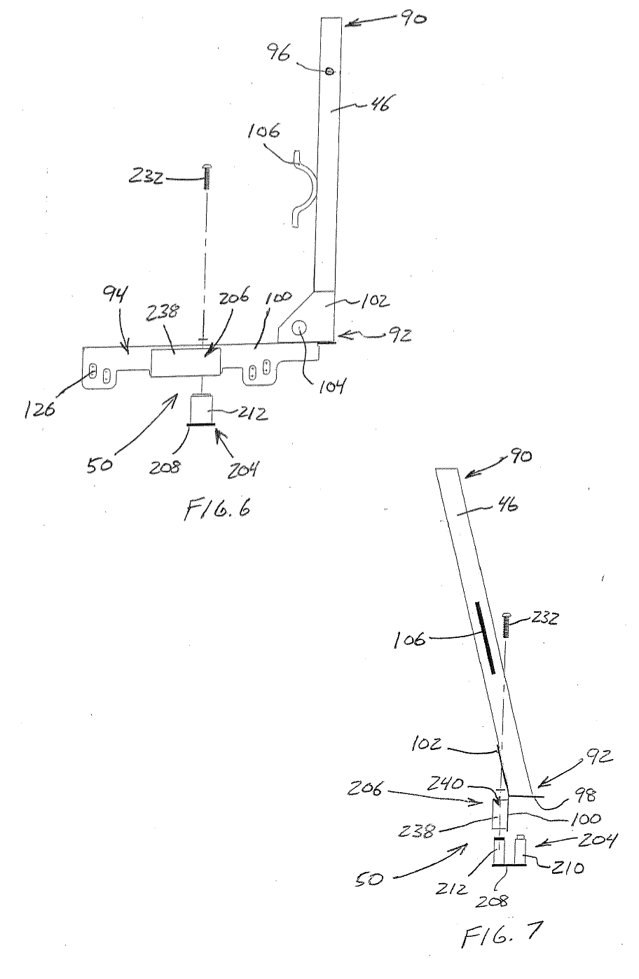

In the preferred embodiment, as shown in FIGS. 2, 3 and 6-13, the clamping assembly 50 generally comprises a generally U-shaped lower clamp assembly 204 and a cooperatively configured upper clamp assembly 206. The lower clamp assembly 204 comprises a platform member 208 having an upwardly extending engaging member 210 and an upwardly extending insert member 212, as best shown in FIGS. 7 through 10. As set forth in more detail below, engaging member 210 is configured to engage the underside surface 214, best shown in FIGS. 2 and 11, of top surface 34 of bedrail 32 and insert member 212 is sized and configured to engage upper clamp assembly 206 when clamp 50 is utilized to securely mount truck rack 10 onto the top surface 34 of bedrail 32. As best shown in FIGS. 8-10, platform member 208 is a generally planar member having a first end 218, a second end 220 and an upwardly facing upper surface 222, with engaging member 210 disposed on upper surface 222 at or near the first end 218 and insert member 212 disposed on upper surface 222 at or near the second end 220 thereof. As shown, engaging member 210 and insert member 212 are in spaced apart relation in order to prevent contact between bedrail 32 and lower clamp assembly 204, except at the upper end 224 of insert member 212 (as described below). Platform member 208, engaging member 210 and insert member 212 should be manufactured out of metal or other materials having suitable strength, rigidity and corrosion resistance for the intended outdoor use on pickup truck 16 or be coated or treated with material, such as powder coating, to provide the desired corrosion resistance. Engaging member 210 and insert member 212 can be tubular or solid members. In one embodiment, platform member 208, engaging member 210 and insert member 212 are separate components that are suitably joined together, such as by welding or the like, to define a single, lower clamp assembly 204. Alternatively, the platform member 208, engaging member 210 and insert member 212 components can be integrally manufactured using processes well known to those skilled in the art of such manufacturing.

In a preferred embodiment, as best shown in FIGS. 7 and 9, the upper end 224 of engaging member 210 is provided with cushioning member 226 that is configured to abut the underside surface 214 of the top surface 34 of bedrail 32 in manner that substantially prevents damage to underside surface 214. As known to those familiar with pickup trucks 16, bedrail 32 thereon is made out of metal that is painted to match the rest of pickup truck 16. Cushioning member 226 is selected so as to prevent or at least substantially reduce the likelihood of damage thereto from the upper end 224 of engaging member 210. In a preferred embodiment, lower cushioning member 226 is a slightly compressible material, such as hard rubber or the like, that prevents damage to underside surface 214 by preventing the upper end 224 of engaging member 210 from contacting the underside surface 214. A variety of other materials may also be suitable for the cushioning member 226.

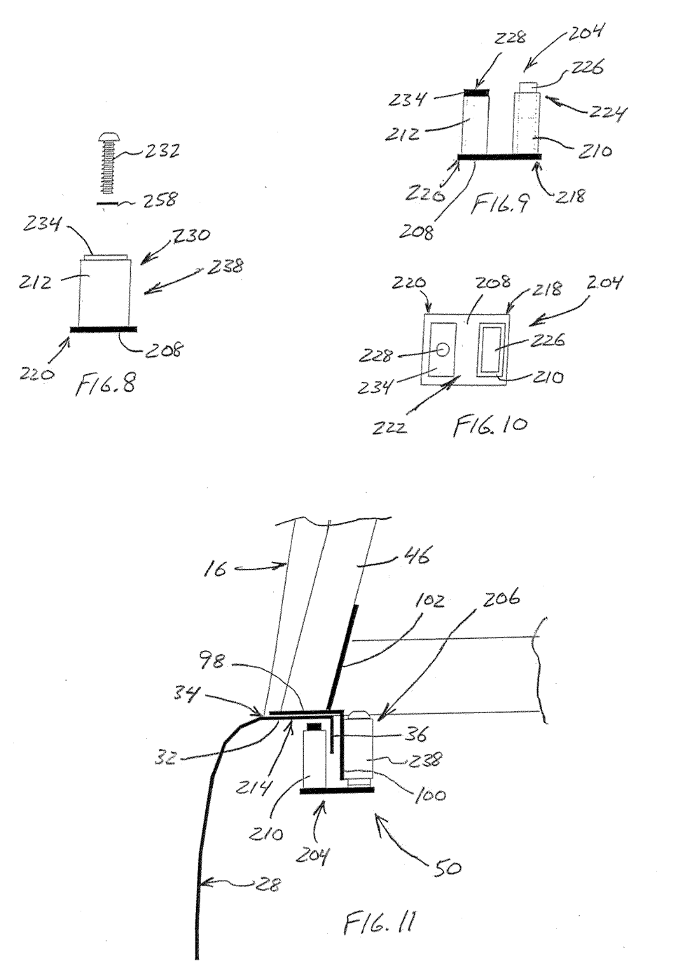

Insert member 212 of lower clamp assembly 204 is configured for use with a means for engaging clamping assembly 50 that connects insert member 212 with upper clamp assembly 206 so as to secure truck rack 10 to bedrail 32 of pickup truck 16. In a preferred embodiment, the engaging means is a threaded aperture 228 at the upper end 230 of insert member 212, as best shown in FIG. 10, sized and configured to receive a like threaded screw 232. If insert member 212 is a solid component, then the threaded aperture 228 can be disposed therein. If insert member 212 is a tubular component, then threaded aperture 228 can provided in a top portion of the tube. The screw 232 and the components of lower clamp assembly 204 are configured such that when the screw 232 is inserted into threaded aperture 228 from the top it will draw the lower clamp assembly 204 upward to simultaneously engage the upper clamp assembly 206 and the underside 214 of the bedrail 32 to clamp the truck rack 10 to the bedrail 32 of the truck 16, as best shown in FIG. 11. In a preferred embodiment, shown in the figures, insert member 212 is tubular and threaded aperture 228 is provided by a cap plate 234, such as a weld nut that is welded onto or otherwise fixedly attached to the upper end 230 of insert member 212, at the upper end 230 of insert member 212. As is apparent to those skilled in the art, various alternative mechanisms can be utilized to join lower clamp assembly 204 to upper clamp assembly 206 than the threaded aperture 228 and screw 232 described above and shown in the figures. Any such mechanism should be chosen to be able to securely, but removably, join lower 204 and upper 206 clamp assemblies to allow the user to easily and quickly install truck rack 202 onto truck 16 or remove it therefrom as he or she may require or desire.

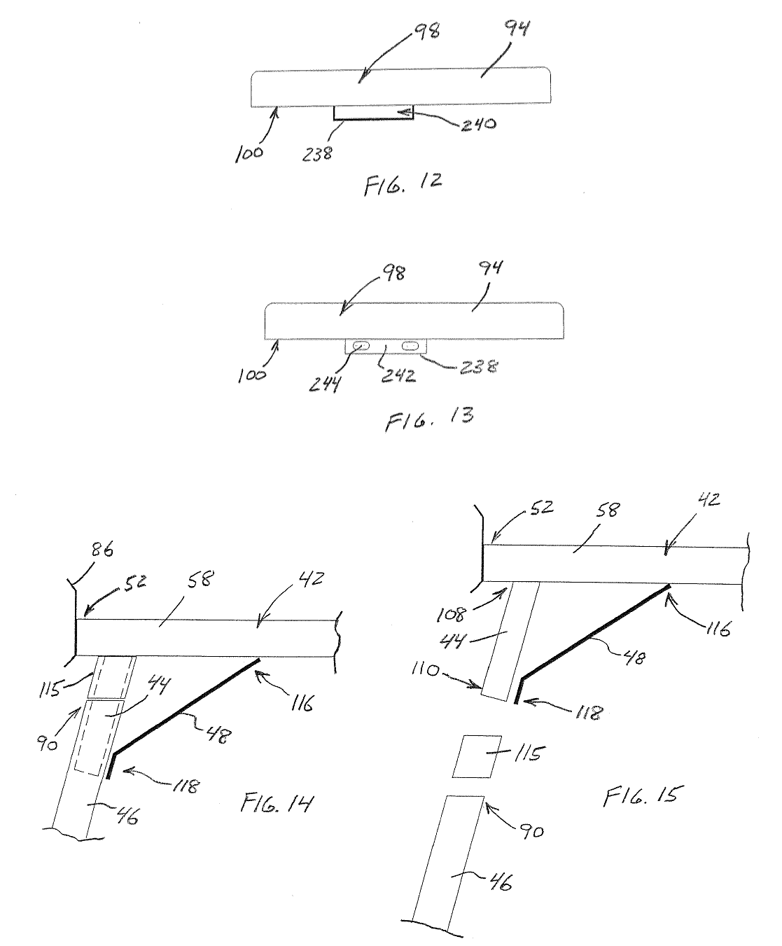

In the preferred configuration of clamping assembly 50, upper clamp assembly 206 comprises a channel member 238 that is fixedly attached to base member 94 so as to define an insert channel 240, as best shown in FIG. 12, to receive insert member 212 therein. In one embodiment, insert channel 240 is sized and configured such that insert member 212 is slidably received therein to allow insert member 212 to move at least somewhat freely relative to insert channel 240 in the direction of base member 94. The size of insert member 212 and insert channel 240 should be selected such that the two components cannot rotate relative to each other, or at least have very limited rotation, and for only limited lateral movement to each other. Because insert member 212 is slidably received in insert channel 240, as best shown in FIG. 11, the lower clamp assembly 204 may move horizontally relative to the channel member 238 of upper clamp assembly 206, inside insert channel 240, so the user can easily adjust the location of lower clamp assembly 204 in light of any obstruction that may be present under bedrail 32. A specially configured washer or other member sized to span between the channel member 238 and the vertical section 100 of base member 96, having an aperture therein to receive screw 232, can be utilized at the top of the insert channel for the screw 232 to engage against to provide the necessary clamping between the lower 204 and upper 206 clamp assemblies. In an alternative embodiment, shown in FIG. 13, channel member 238 has a top wall 242 to engage screw 232 with one or more apertures 244 therein to receive screw 232 so that it may threadably engage the insert member 212 to clamp the lower 204 and upper 206 clamp assemblies together. As with the components of lower clamp assembly 204, channel member 238 of upper clamp assembly 206 should be manufactured out of metal or other materials having suitable strength, rigidity and corrosion resistance for the intended outdoor use on pickup truck 16 or which may be coated or treated with another material, such as by powder coating, to provide the desired corrosion resistance. In one embodiment, channel member 238 is fixedly attached, such as by welding or the like, to vertical section 100 of base member 94 to define the upper clamp assembly 206. Alternatively, channel member 238 can be integrally manufactured with the base member 94.

In one configuration of clamping assembly 50 of the truck rack 10 of the present invention, channel member 238 is a generally C-shaped component that is fixedly attached (i.e., by welding) to the side of the vertical section 100 that is disposed inside rear cargo area 20 of truck 16 when truck rack 10 is installed on truck 16, as best shown in FIGS. 2 and 7, with insert channel 240 disposed between the inner side of vertical section 100 and channel member 238, as best shown in FIG. 12. As set forth above, insert member 212 is removably received in the insert channel 240 defined by channel member 238. In this configuration, vertical section 100 of base member 94 will be disposed between the engaging member 210 and the insert member 212, as best shown in FIGS. 2 and 7. When in use, as shown in FIGS. 2 and 11, cushioning member 226 at the upper end 224 of engaging member 210 will be against the underside 214 of bedrail 32. Depending on the strength of materials and connections used for clamping assembly 50, one advantage of this embodiment of clamping mechanism 50 is that the portion of insert channel 240 not occupied by insert member 212 can be utilized as a tie-down location. If the materials and/or connections are not configured with sufficient strength to be used as a tie-down, then the user of truck rack 10 should be warned not to use this space for tying down the cargo as such use could result in damage to the truck rack 10, truck 16 and/or the cargo being carried on rack 10 and possible injury to the user and/or others.

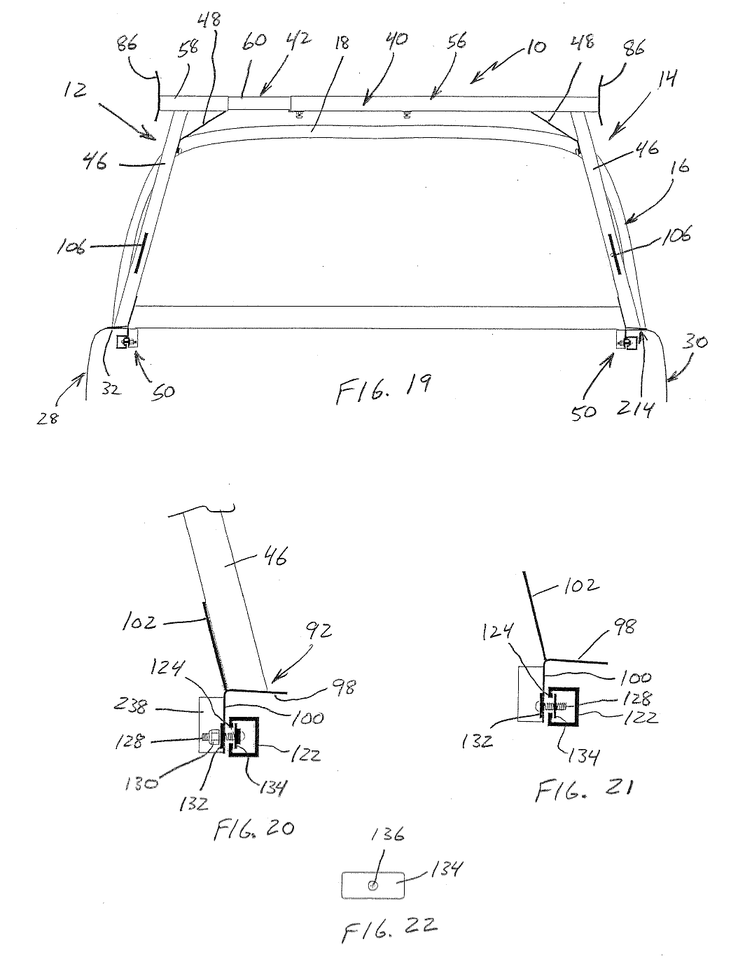

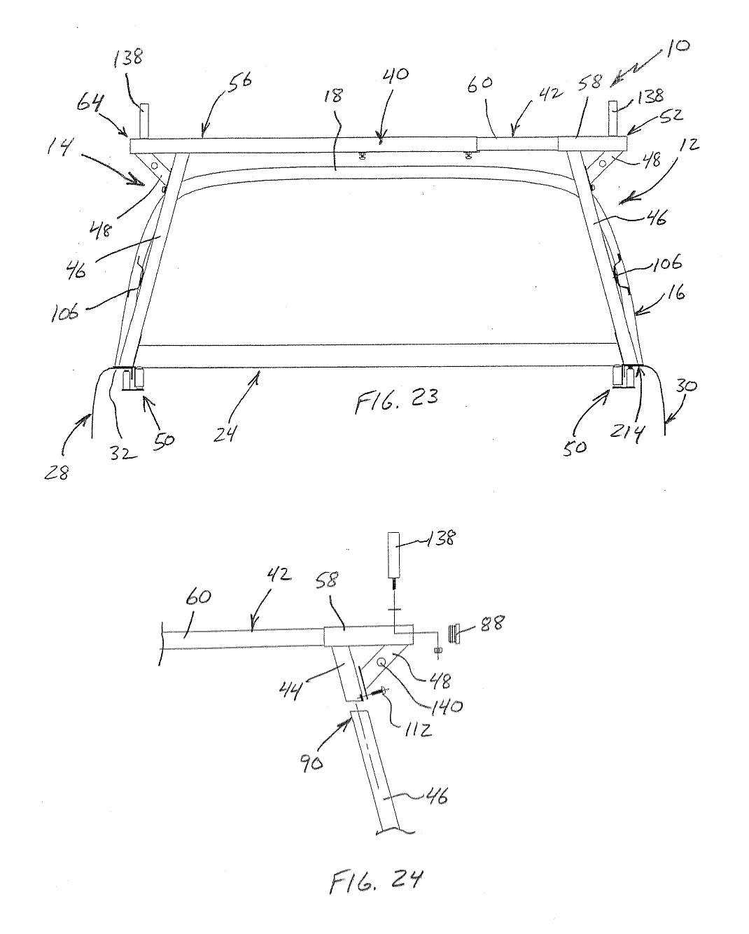

In an alternative configuration of clamping assembly 50 used with truck rack 10 of the present invention, shown in FIGS. 19 through 22, the truck rack 10 is configured to be secured to the truck 16 by utilizing the accessory track 122 that is provided by the manufacturer for some models of trucks 16. These accessory tracks 122 are provided with a slot 124 facing inward to rear cargo area 20 and are configured to be utilized with various accessory items, such as cleats, eye hooks and the like. For the present invention, the accessory track 122 and slots 124 therein are utilized with base member 94 to secure the first 12 and second 14 rack assemblies of truck rack 10 onto the bedrail 32 of the sidewalls 28 and 30, as best shown in FIG. 19. To facilitate such use, base member 94 is provided with one or more clamping apertures 126, shown in FIG. 6, that are cooperatively positioned with slot 124 such that they are generally aligned when horizontal section 98 and vertical section 100 of base member 94 are in abutting relation to the top surface 34 and lip 36 of bedrail 32. The clamping assembly 50 of this embodiment additionally comprises a threaded bolt 128 that is sized and configured to extend through slot 124, a lock nut 130 that is threadably received on bolt 128, one or more washers 132 and a clamp plate 134 having an aperture 136, as shown in FIG. 20, though which the bolt 128 passes. In the embodiment of FIG. 20, the bolt 128 is inserted through the aperture 136 of plate 134 and then the plate 134 is inserted into accessory track 122 with the bolt 128 extending out of the track 122 toward the rear cargo area 20 and through one of the clamping apertures 126. The washer 132 and then the nut 130 are placed over the bolt 128 and the nut is threadably secured to the bolt 128 to draw the clamp plate 134 against the interior wall of the track 122 by slot 124 and the vertical section 100 of the base member 94 against the outer wall of the track 122 at the slot 124 to secure the truck rack 10 to the bedrail 32. In the embodiment of FIG. 21, the clamp plate 134 is placed inside the accessory track 122 and the bolt 128 is placed through one of the clamping apertures 126 in vertical section 100 of base plate 94, with washer 132 therebetween, to pass through aperture 136 in clamp plate 134. In the preferred embodiment of this configuration, bolt 128 threadably engages a threaded aperture 136, thereby eliminating the need to utilize nut 130. When bolt 128 is engaged, vertical section 100 of base plate 94 will be pressed against the accessory track 122 to securely mount truck rack 10 to truck 16.

Although the foregoing description includes threaded screw 232 and bolt 128 as the connecting mechanisms to clamp the lower 204 and upper 206 clamp assemblies together or attach to accessory track 122 when securing the base member 94 of truck rack 10 to the bedrail 32 of pickup truck 16, a variety of other connecting mechanisms can be utilized instead of screw 232 or bolt 128, including various other types of screws, bolts and other connectors that are likely to suffice for clamping assembly 50 of the present invention. In a preferred embodiment, any such connecting mechanism includes some type of security feature to at least make it difficult for unauthorized persons to disengage clamping assembly 50 and remove truck rack 10 from pickup truck 16. In a preferred embodiment, with threaded screw 232 or bolt 128 as the connecting mechanism, a security feature is incorporated into the drive opening of the head of screw 232 or bolt 128. The security feature can be as simple as a Torx® or similar type of less common drive opening, compared to slotted or Phillips heads, that reduces the likelihood that a potential thief will be able to easily remove truck rack 10 from pickup truck 16. For additional security, the security feature can be selected to require the use of a specially configured driver that is not readily available to the public or the use of a custom made, proprietary driver that is not available to the public at all. As known in the art, tamper resistant screws and bolts utilize specially designed drive openings, some of which may include one or more upwardly extending pins therein for additional security, that can only be engaged by a cooperatively configured bit which is supplied to the user when ordering the screws or bolts. Many of the designs for the security feature are proprietary, such that only the user is supplied with the driver bits that fit the drive opening of threaded screw 232 or bolt 128. Use of such proprietary features can essentially make clamping assembly 50 tamper proof. With a tamper resistant security feature incorporated into screw 232 or bolt 128, the user can be relatively confident that an unauthorized persons will not be able to disengage clamping assembly 50 to remove truck rack 10 from pickup truck 16.

An alternative embodiment of the truck rack 10 of the present invention is shown in FIGS. 23 and 24. In this embodiment, the open tubular ends of the interconnected span member 40, which are the first end 52 of first span member 42 and the second end 64 of second span member 56, are closed with cap 88, as shown in the exploded view of FIG. 24, instead of an ear member 86. To help keep the load on top of the truck rack 10, without the upper portion of the ear member 86 being available, this embodiment utilizes a nut tube 138 that is attached to the top surface of each span member 42/56 near the respective ends 52 and 64 thereof. In the preferred embodiment, nut tube 138 is removably connected to span members 42/56 for ease of storage and shipping and to allow variations to the size of this component based on the user's needs. To assist with securing the cargo on truck rack 10, an aperture 140 is provided in gusset member 48, as best shown in FIG. 24, to be utilized with ropes or other tie-down members. The gusset member 48 in this embodiment is a tubular member that is positioned on the side of truck rack 10 opposite that shown in the previous embodiments, in a position that generally connects leg member 46 with ends 52 and 64 of the respective span members 42/56. As with the other embodiments, the tubular upper end 90 of leg member 46 slides over the engaging member 44 to abut the bottom surface of the respective span members 42/56 and a screw or bolt 112 is utilized to interconnect the engaging member 44, leg member 46 and gusset member 48. The interconnected span member 40 and the clamping assembly 50, utilizing the U-shaped lower clamp assembly 204, are the same as that set forth above for the previously described embodiments.

A variety of other alternative embodiments can be configured for the truck rack 10 of the present invention. For instance, the interconnected span member 40 can comprise a center tubular span member that receives or is received in the ends of the first 42 and second 56 span members that are then connected using a connecting element. The leg members 42 can be configured as a single tubular member, as shown, or leg members 42 can comprise two or more components that are joined together to form leg members 42 to further reduce the cost of shipping and allow variations in the size of truck rack 10. If desired, the components for leg members 42 can be telescopically configured so the user can adjust the height of the truck rack 10 for his or her truck 16. Other configurations for the engaging members 44 and gusset member 48 can also be utilized with truck rack 10 of the present invention. Likewise, clamping assembly 50 can be modifications of the two embodiments described above or other types of clamping assemblies can be utilized to secure truck rack 10 to truck 16.

In use, the user will assemble truck rack 10 by inserting the upper end 90 of leg member 46 over the lower end 110 of engaging member 44 until the upper end 90 of leg member 46 abuts the bottom side of each of the first 42 and second 56 span members and then inserting screw 112 through the hole or slot at the lower end 118 of gusset 48 to threadably engage the nut 114 inside the tubular lower end 110 of engaging member 44 to secure the leg 46 to the span members 42/56. The user then insets the second section 60 of the first span member 42 into the tubular first end 62 of the second span member 56 to form the interconnected span member 40 and utilize screws 66 and 72 to secure the two span members 42/56 together. The user then places the base members 94 of each of the first 12 and second 14 rack assemblies onto the bedrails 32 of the sidewalls 28 and 30, with the horizontal section 98 resting on the top surface 34 of bedrail 32 and the vertical section 100 against lip 36 of bedrail 32, to position the interconnected span member 40 above the bed 22 of truck 16. For truck 16 having conventional bedrails 32, the user will utilize the U-shaped lower clamp assembly 204 to secure truck rack 10 to truck 16 by inserting the insert member 212 inside the insert channel 240 of channel member 238 and positioning the engaging member 210, having cushioning member 226, such that it is under the underside 214 of bedrail 32. When the screw 232 is threaded into aperture 228, cushioning member 226 is pressed against the underside 214 of bedrail 32 and horizontal section 98 of base member 94 is clamped against the top surface 34 of bedrail 32 to secure truck rack 10 to truck 16. For trucks 16 having an accessory track 122, the user places the clamp plate 134 inside the track with the threaded end of bolt 128 extending through aperture 136 in clamp plate 134 and outward through the slot 124 of the accessory track 122 into rear cargo area 20, passing through one of the clamping apertures 126 in the base member 94. The user then places a washer 132 over the bolt 128 and threads the nut 130 onto the bolt 128 to clamp the base member 94 to the accessory track 122 to secure the truck rack 10 to the truck 16. Alternatively, the bolt 128 is placed through one of the clamping apertures 126 of base member 94, through slot 124 and into the accessory track 122 where it threadably engages the aperture 136 in clamp plate 134 to clamp the vertical section 100 of base member 94 against the accessory track 122 to secure the truck rack 10 to the truck 16. Removal of truck rack 10 from truck 16 is accomplished by generally reversing the installation steps set forth above.

As will be readily apparent to those skilled in the art, truck rack 10 described above has numerous advantages over prior art truck racks, including the ability to quickly and easily assemble the truck rack 10 on the truck 16 and to disassemble the truck rack 10 into relatively small, easy to handle, store and ship components. The configuration of truck rack 10, particularly the use of the inclined engaging members 44 and that connect to the cooperatively inclined leg members 46 and the use of a gusset member 48 to connect span members 42/56 to their respective engaging member 44 and leg member 46, allows the user to carry heavy loads while allowing the manufacturer to utilize lightweight materials for the components of the truck rack 10. The junction of the span member 42/56, engaging member 44, leg member 46 and gusset member 48 provides corners which are independently stable for the truck rack 10. Only a few screws, bolts or other connecting elements are required to connect the various components into truck rack 10. The integrated clamping assembly 50 allows use of truck rack 10 with trucks 16 having conventional bedrails 32 and sidewalls with accessory tracks 122. The U-shaped lower clamp assembly 204 removably clamps truck rack 10 to the to the bedrails 32 without utilizing the stake pockets 38 or requiring any holes or other modifications to be made to the bedrails 32. Use of the clamp plate 134 inside the accessory track 122 provides a quick and easy to use clamping system for those trucks 16 that have such accessory tracks 122. The preferred clamping assemblies 50 are compact so as to not interfere with ropes or other cargo securing devices and resist being knocked loose by any movement of the cargo. The clamping assemblies do not interfere with the use of tool boxes or other accessories that sit on the bedrail 32 of the truck 16. The use of the double set screws 66 and 72, one of which penetrates the span members 42/56 and one which engages a connecting plate 74, securely joins these two components together in a manner that does not damage the finish on the span members 42/56. The use of the ear members 86 helps secure the cargo on truck rack 10 and provides loops below the horizontal plane of integrated span member 40 for attaching hooks and/or loops. One benefit of truck rack 10 is that it can be quickly and easily moved from one truck 16 to another 16 for use thereon.

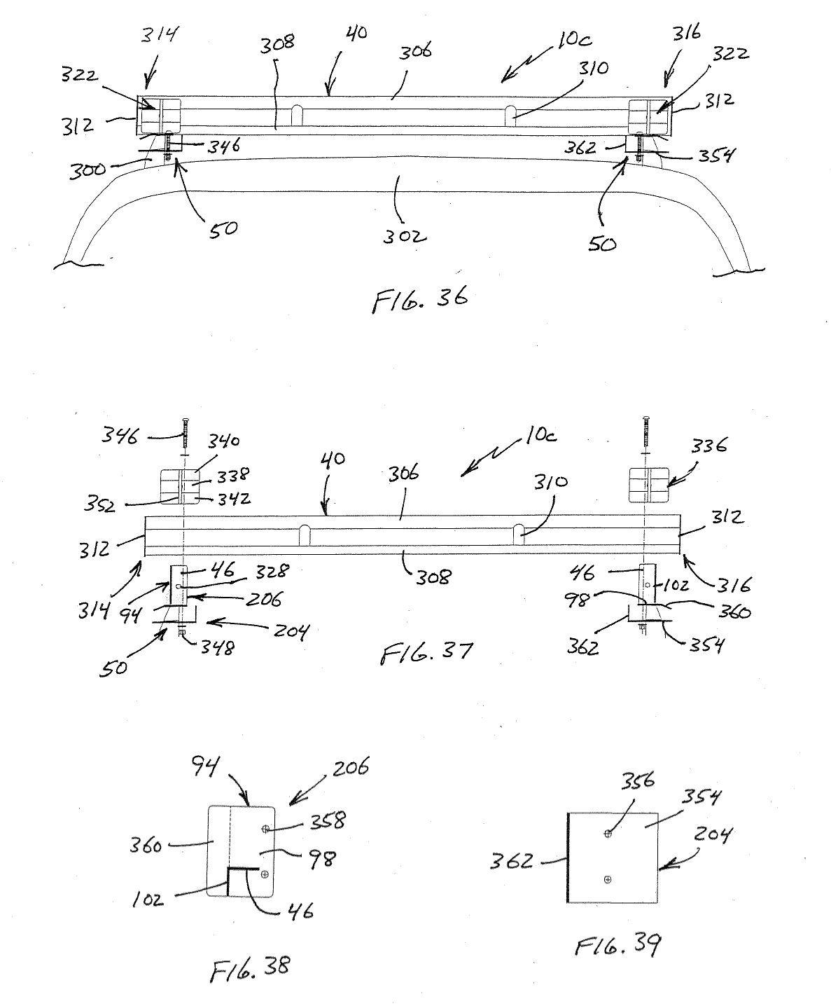

A rack 10 configured according to the present invention is shown in FIGS. 25 through 39. FIGS. 25 through 34 show use of the rack 10 of the present invention being utilized as a truck rack that is mounted to the generally parallel, spaced apart bedrails 32 or accessory tracks 122 on the left 28 and right 30 sidewalls of a pickup truck 16. FIGS. 35 through 39 show rack 10 of the present invention being utilized as a roof rack that is mounted to the generally parallel, spaced apart cargo rails 300 on the roof 302 of a SUV 304 or above cab 18 of pickup truck 16. FIG. 25 shows use of rack 10 as both a truck rack and a roof rack that cooperate together to support a load thereon. For pickup truck 16, the bed 22 thereof is a rack support surface, from which the sidewalls 28/30 extend upwardly with the bedrails 32 or accessory tracks 122 thereon being rack mounts to which rack 10 mounts. For SUV 304, the roof 302 is the rack support surface, on which are mounted the cargo rails 300, as the rack mounts, and to which the rack 10 mounts. As with the above described rack embodiment, rack 10 of the present invention is typically utilized as a pair to form a truck rack system that comprises a first or forwardly disposed rack 10a and a second or rearwardly disposed rack 10b or a roof rack system having a first or forwardly disposed rack 10c and a second or rearwardly disposed rack 10d. Typically, racks 10a and 10b will be identically configured and racks 10c and 10d will be identically configured, depending whether rack 10 is desired for use as a truck rack or a roof rack. Alternatively, one or more of the racks 10a and 10b can be utilized with one or more of the racks 10c and 10d, as shown in FIG. 25. For purposes of the present disclosure, racks 10a, 10b, 10c and 10d are generally referred to herein as rack 10 and the term “vehicle” is used to refer to both the pickup truck 16 and SUV 304. The term “rack support surface” refers to the bed 22 and roof 302 of the vehicle 16/304 and the term “rack mount” is used to refer to the bedrails 32, accessory tracks 122 and cargo rails 300 of vehicle 16/304, as applicable depending on whether the rack 10 is being used as a truck rack or as a roof rack.

Racks 10a and 10b are attached to bedrails 32 or accessory tracks 122 in spaced apart relationship to each other and racks 10c and 10d are attached to cargo rail 300 in spaced apart relationship to each other to support a load, such as ladders, pipe, lumber, canoes and other cargo (not shown), above the bed 22 and/or above the roof 302, as applicable, of vehicle 16/304. As will be readily understood by those skilled in the art, rack 10a and rack 10b can be moved generally anywhere along bedrails 32 or accessory racks 122 to change the spacing between racks 10a/10b and rack 10c and rack 10d can be moved generally anywhere along the cargo rails 300 to change the spacing between racks 10c/10d where desired for the racks 10a/10b or 10c/10d to be located to best support the cargo to be carried on truck 16 or SUV 304.

As with the rack of the above-described embodiment, rack 10 of the present invention generally has a first rack assembly 12 and a second rack assembly 14 that cooperatively join together with span member 40, as set forth below, to define a single rack 10. For the truck rack embodiment, the span member 40 is supported above the bed 22 of the pickup truck 16 in a generally transverse relationship to the bed 22 by the first 12 and second 14 rack assemblies, as best shown in FIGS. 26 and 27. The first rack assembly 12 and second rack assembly 14 of racks 10a/10b are mounted to a bedrail 32 or an accessory track 122 on the opposing sidewalls 28 and 30. For the roof rack embodiment, the span member 40 is supported above the roof 302 of the SUV 304 or pickup truck 16 in a generally transverse relationship to the roof 302 by the first 12 and second 14 rack assemblies, as best shown in FIG. 36. The first rack assembly 12 and the second rack assembly 14 of racks 10c/10d are mounted to the spaced apart cargo rails 300. In one embodiment, the first 12 and second 14 rack assemblies are fixedly attached to either bedrails 32, accessory tracks 122 or the cargo rails 300 of a pickup truck 16 or SUV 304, typically requiring drilling or other modification to the vehicle 16/304 or the cargo rails 300. Preferably, however the rack 10 of the present invention is configured such that the first 12 and second 14 rack assemblies will removably attach to bedrails 32, accessory tracks 122 or cargo rails 300 of pickup truck 16 or SUV 304. In the preferred embodiment of rack 10, a clamping assembly is utilized to clamp the rack 10 to the bedrails 32, accessory tracks 122 or cargo rails 300.

In the preferred embodiment of the present invention, the first 12 and second 14 rack assemblies support a truss-shaped, elongated span member 40 above the rack support surface 22/302 of vehicle 16/304, as best shown in FIGS. 26, 27 and 36. The span member 40 of the present invention comprises two separate elongated mounting crossbars, namely a first mounting crossbar 306 and a second mounting crossbar 308. As set forth below, the first 306 and second 308 mounting crossbars are sized and configured for the user to attach one or more accessory attachments thereto so that he or she may utilize the accessory attachments for carrying one or more bicycles, canoes, kayaks, snowboards, skis or other items. Presently, accessory attachments only attach, typically by clamping, to a particular manufacturer's rack system due to the fact that the each manufacturer utilizes a different size and/or cross-sectional shape of crossbar for their rack system, which prevents one manufacturer's accessory attachments being utilized on a rack system from a different manufacturer. The clamping mechanism or other device for securing the accessory attachments to the present crossbars typically encircle or otherwise enclose the crossbar to which it is mounted. The rack 10 of the present invention provides two mounting crossbars 306/308, either of which can selectively be utilized to secure one or more accessory attachments. In the preferred embodiment of the rack 10 of the present invention, the mounting crossbars 306/308 are configured to utilize the presently available accessory attachments and the mechanisms that secure the accessory attachments to the manufacturer's crossbars, such as those available from either Thule or Yakima.

To facilitate the use of one or more presently available accessory attachments and their associated securing mechanisms with the first mounting crossbar 306 or the second mounting crossbar 308, the first 306 and second 308 mounting crossbars should be sufficiently spaced apart from each other for the accessory attachments' securing mechanisms to securely attach the accessory attachments to the appropriate mounting crossbar 306/308. In a preferred embodiment, the first 306 and second 308 mounting crossbars are maintained in spaced apart relation by a crossbar spacing means that interconnects the two mounting crossbars 306/308. In the preferred embodiment of the present invention, the crossbar spacing means comprises one or more crossbar spacing members 310 (two shown in the figures) that are disposed between the first 306 and second 308 mounting crossbars and are sized and configured to maintain the mounting crossbars 306/308 in the desired spaced apart relation. Alternatively, the spacing means can comprise an end plate 312 at both the first end 314 and the second end 316 of the span member 40 that is sized and configured to maintain the necessary spacing for the mounting crossbars 306/308. In the preferred embodiment, the truss-shaped span member 40 uses both the crossbar spacing members 310 and the end plates 312 to provide a stronger, more stable structure. Preferably, the mounting crossbars 306/308 are tubular, to reduce the weight of the rack 10, with the end plates 312 also being configured to close the otherwise open ends of the tubular mounting crossbars 306/308. If end plates 312 are not needed for structural support, various end caps, ear members or the like can be utilized instead of or in addition to end plates 312 to close off the open ends of the tubular mounting crossbars 306/308.

In the preferred embodiment of the present invention, the mounting crossbars 306/308 of span member 40 are configured such that when the span member 40 is disposed in its generally vertical arrangement, as best shown in FIGS. 25, 29 and 35, the two mounting crossbars 306/308 are substantially in the same plane with one mounting crossbar 306/308 positioned generally above the other for use to attach one or more accessory attachments thereto. As set forth in more detail below, in the preferred embodiment of the rack 10 of the present invention span member 40 is connected to and supported by the first 12 and second 14 rack assemblies in a manner that allows the user to easily and quickly flip the span member 40 over such that the other mounting crossbar 306/308 is on top and can be utilized for attaching one or more accessory attachments thereto. As set forth below, this configuration substantially increases the functionality and versatility of rack 10 relative to presently available rack systems, which only have a single crossbar, per rack assembly spanning across the bed 22 or roof 302 of a vehicle 16/304 for use to support accessory attachments.

As shown in FIG. 29, the first mounting crossbar 306 has a first cross-section 318 and the second mounting crossbar 308 has a second cross-section 320. For purposes of the present disclosure, the first 318 and second 320 cross-sections refer to the size and shape (or configuration) of the mounting crossbars 306/308 when viewed from a cross-sectional position thereof, as is shown in FIG. 29. In one embodiment, the first cross-section 318 of the first mounting crossbar 306 can be the same as the second cross-section 320 of the second mounting crossbar 308, meaning that both mounting crossbars 306/308 would have the same size and shape. Generally, this configuration would not be preferred as it would not provide one of the primary benefits of the rack of the present invention, namely the ability to utilize different configurations of accessory attachment securing mechanisms, as are typically provided by different rack system manufacturers.

For the preferred embodiment of the rack 10 of the present invention, the first cross-section 318 is in contrasting relation to (or different than) the second cross-section 320, meaning that the size and/or shape of the two cross-sections 318/320 are different. In the embodiment shown in the figures, the first mounting crossbar 306 has a first cross-section 318 which is round and the second mounting crossbar 308 has a second cross-section 320 which is rectangular. The size and shape of the mounting crossbars 306/308 should be selected so as to correspond to presently available securing mechanisms that are utilized to secure accessory attachments to crossbars. As known to those skilled in the art, Yakima utilizes crossbars with round cross-sections and Thule utilizes crossbars with rectangular cross-sections. Utilizing properly sized mounting crossbars 306/308, the span member 40 of rack 10 of the present invention allows the user to attach accessory attachments from either Thule or Yakima to his or her rack 10 using the presently available accessory attachment securing mechanisms. As a result, the user can select the accessory attachments from Thule and Yakima that he or she desires without having to have two separate rack systems. In addition, a person could borrow another person's accessory attachments and utilize them with his or her rack and a person could borrow a vehicle 16/304 having rack 10 thereon from another person and utilize his or her own accessory attachments even if the rack systems and accessory attachments are made by different companies.

As set forth above, first rack assembly 12 and second rack assembly 14 cooperate together with the rack mounts (i.e., bedrails 32, accessory tracks 122 or cargo rails 300) to support the span member 40 above the rack support surface, typically either bed 22 or roof 302. Each of the first 12 and second 14 rack assemblies have a leg member 46, a rack mounting means disposed at or near the lower end 92 of the leg member 46 for mounting the respective rack assembly 12/14 to the bedrails 32, accessory tracks 122, cargo rails 300 or other rack mounts and a span engaging means disposed at or near the upper end 90 of the leg member 46 for engaging the span member 46 so as to support the span member 40 above the bed 22, roof 302 or other rack support surface. The rack mounting means and span engaging means of rack 10 can have a wide variety of different configurations, including those which fixedly attach these components to the rack mounts or span member, as applicable. In one embodiment, the rack mounting means can be configured such that the user fixedly attaches the lower end 92 of leg member 46 to the bedrails 32, accessory tracks 122, cargo rails 300 or other rack mounts by drilling holes in the rack mounts, welding the leg member 46 or an attachment thereto to the rack mount or other known means of fixedly attaching leg member 46 to a rack mount. Likewise, the span engaging means can be selected so as to fixedly attach the upper end 90 of leg member 46 to the span member 40, such as be welding, riveting or like means of fixedly attaching a leg member to a span. As set forth in more detail below, however, preferably the rack 10 attaches to vehicle 16/304 without requiring any holes, welding or any other modification to the vehicle 16/304 or any of the rack mounts, so as to not damage the vehicle 16/304, and the leg member 46 removably connects to the span member 40, for ease of installation, removal, storage and shipping. In the preferred embodiment, a clamping assembly 50 releasably clamps the lower end 92 of leg member 46 to the bedrails 32, accessory tracks 122, cargo rails 300 or other rack mounts of vehicle 16/304 and a span clamp assembly 322 releasably clamps the upper end 90 of leg member 46 to the span member 40.

In the preferred embodiment of the rack 10 as a truck rack, shown in FIGS. 25 through 34, the leg members 46 are tubular and are inclined inwardly relative to the sidewalls 28/30 that support the bedrails 32 or accessory tracks 122 to which the rack 10 attaches. In the preferred embodiment, leg member 46 has a closed upper end 90 and an open lower end 92 that joins to base member 94, which is configured to abut bedrail 32 and support leg 46 on the sidewalls 28 and 30 of pickup truck 16. In the preferred embodiment, base member 94 has a substantially horizontal section 98 that is configured to abut the top surface 34 of the bedrail 32 and a generally vertical section 100 that is configured to abut the inside lip 36 of bedrail 32 when rack 10 is supported on sidewalls 28 and 30, as best shown in FIGS. 26 and 27. As set forth in more detail below, clamping assembly 50 is configured to cooperatively engage the base member 94 so as to securely attach rack 10 to bedrails 32 or accessory tracks 122 of truck 16 during use of rack 10. In the preferred embodiment, the open lower end 92 of leg member 46 receives an upwardly disposed tube engaging member 324 that is fixedly attached, typically be welding or the like, to the top side of the horizontal section 98 of base member 94, as best shown in FIG. 30. The tube engaging member 324 is sized and configured to be received into the lower end 92 of leg member 46 and support leg member 46 at the desired inclined angle. A screw or other connector 326 is utilized through apertures provided at the lower end 92 of leg member 46, tube engaging member 324 and support plate 102 to connect these components together and support leg member 46 above the bedrail 32 of the pickup truck 16. Being able to separate the leg member 46 from the base member 94 provides for ease of handling, storing and shipping rack 10 of the present invention. When separated, the various components of truck rack 10 can fit into a relatively narrow and easy to handle box that reduces shipping costs by fitting within certain size guidelines that have been established by shipping companies. Alternatively, leg member 46 can be pivotally attached to the base member 94 with support plate 102, which is attached to base member 94 by welding or other means appropriate for the materials utilized, so leg member 46 may be folded onto base member 94. This also provides for ease of handling, storing and shipping. In an alternative embodiment, the leg member 46 can be fixedly attach to base member 94. If desired, one or more apertures 104 can be provided in support plate 102 for use as a tie-down hole to engage hooks, ropes or other cargo supporting devices. Preferably, leg member 46 also includes one or more tie-down cleats 106 (shown with the embodiment described above and shown in FIGS. 2-3 and 6-7) that are welded or otherwise securely attached to one or more sides of leg member 46 to be utilized for looping ropes or other cargo-securing mechanisms.

In one embodiment of the present invention, the leg members 46 are substantially vertical or angled outwardly from side walls 28/30. In the preferred embodiment of rack 10 of the present invention as a truck rack, however, the leg members 46 of both the first 12 and second 14 rack assemblies incline inwardly, relative to the generally vertical sidewalls 28 and 30, such that leg members 46 are angled toward each other, as best shown in FIGS. 26 and 27, in order to more effectively resist right-to-left horizontal movement (shearing strain). In one embodiment, leg members 42 are inclined inwardly approximately fifteen degrees from vertical.

In a preferred embodiment of the present invention, leg members 46 have a plurality of span connecting apertures 328 positioned towards the upper end 90 of each leg member 46, as best shown in FIGS. 26 and 27, to allow the user to select height of the span member 40 relative to the bed 22 and bedrails 32 when he or she connects the span member 40 to the leg members 46. As set forth in more detail below, the span connecting apertures 328 on leg members 46 are positioned to cooperate with the preferred span engaging means such that the user selects the height he or she wants the mounting crossbar 106/108 that is the upper crossbar, and therefore the crossbar to which the user will attach the accessory attachments, to be at when using rack 10. In some circumstances, such as shown in FIG. 25, the user will select the height of the upper crossbar of span member 40 of the truck rack to correspond to the height of the upper crossbar of the span member 40 of the roof rack. In an alternative embodiment, the leg members 46 can be telescopically configured to allow the user to adjust the height of span member 40 above the bed 22 and bedrails 32 of the pickup truck 16.

As set forth above, the rack mounting means that attaches the lower end 92 of leg member 46, by use of base member 94, to the bedrail 32 or the accessory track 122 of pickup truck 16 can have a wide variety of different configurations, including being fixedly attached or have a clamping assembly 50 such as those described above with regard to the embodiments shown in FIGS. 1 through 24. In the embodiments of FIGS. 25 through 39, the clamping assembly 50 is slightly modified. FIGS. 26 and 27 show use of a pickup truck 16 utilizing a clamping assembly 50 that clamps to the bedrails 32 on the left side of the figures and a clamping assembly 50 that clamps to the accessory track 122 on the right side of the figures. As well known in the art, normally a person would only utilize one of these types of clamping assembly 50 to secure rack 10 to any specific pickup truck 16. The combination is merely shown for purposes of describing the present invention.

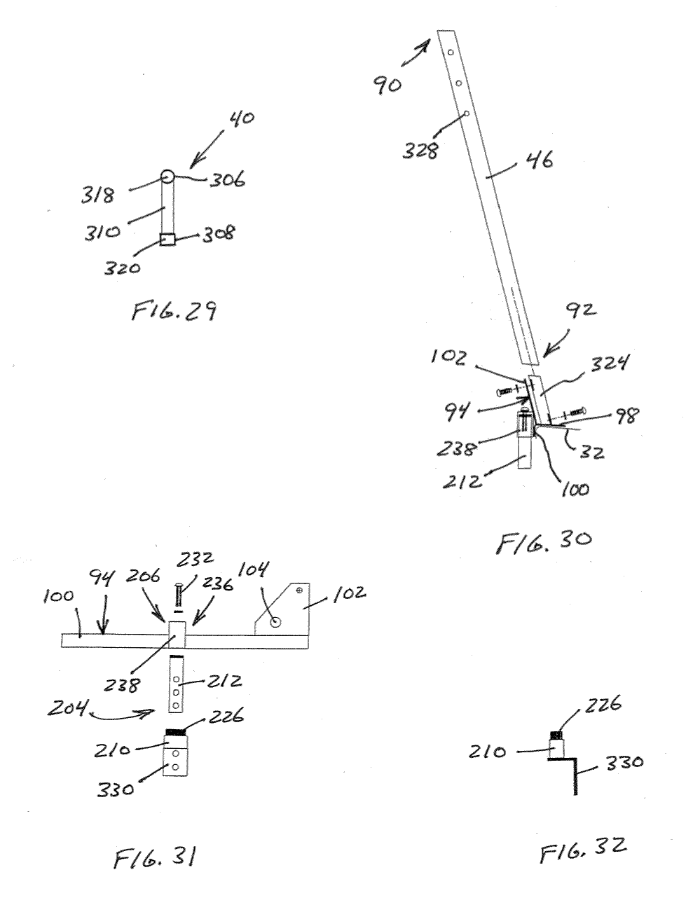

The clamping assembly 50 utilizes an inverted L-shaped brace member 330, best shown in FIG. 32, to form a generally U-shaped lower clamp assembly 204 that engages a cooperatively configured upper clamp assembly 206. The lower clamp assembly 204 comprises an upwardly extending engaging member 210 and an upwardly extending insert member 212 that are attached to the L-shaped brace member 330, as best shown in FIGS. 31 and 32. In the preferred embodiment, the engaging member 212 is fixedly attached to brace member 330. As set forth in more detail below, the engaging member 210 is configured to engage the underside surface 214, as best shown in FIGS. 26 and 27, of bedrail 32 and insert member 212 is sized and configured to engage upper clamp assembly 206 when clamp assembly 50 is utilized to securely mount rack 10 onto the top surface 34 of bedrail 32. As shown, the L-shaped brace member 330 maintains engaging member 210 and insert member 212 in spaced apart relation to prevent contact between bedrail 32 and lower clamp assembly 204, except at the upper end of the engaging member 210 (as described below). Platform member 208, engaging member 210 and insert member 212 should be manufactured out of metal or other materials having suitable strength, rigidity and corrosion resistance for the intended outdoor use on pickup truck 16 or be coated or treated with material, such as powder coating, to provide the desired corrosion resistance. In addition, engaging member 210 and insert member 212 can be tubular or solid members.

In the preferred embodiment, the upper end of engaging member 210 is provided with cushioning member 226 that is configured to abut the underside surface 214 of bedrail 32 in manner that substantially prevents damage to underside surface 214. As known to those familiar with pickup trucks 16, bedrail 32 thereon is made out of metal that is painted to match the rest of pickup truck 16. The material for cushioning member 226 is selected to prevent or at least substantially reduce the likelihood of damage thereto from the upper end of engaging member 210. In a preferred embodiment, cushioning member 226 is a slightly compressible material, such as hard rubber or the like, that prevents damage to underside surface 214 by preventing the upper end of engaging member 210 from contacting the underside surface 214. A variety of other materials may also be suitable for the cushioning member 226.

In a preferred embodiment, insert member 212 is attached to the L-shaped brace member 330 with a bolt, screw or other connector that passes through at least one of the apertures in insert member 212 and L-shaped brace member 330. Preferably, multiple apertures are provided to allow the user of rack 10 to adjust the positioning of the clamp assembly 50. The upper end of insert member 212 has a threaded aperture 228, as best shown in FIG. 10, that is sized and configured to receive a threaded screw 232 to secure insert member 212 to the upper clamp assembly 206. When attached, the components of lower clamp assembly 204 are configured such that when the screw 232 is inserted into threaded aperture 228 from the top it will draw the lower clamp assembly 204 upward to simultaneously engage the upper clamp assembly 206 and the underside 214 of the bedrail 32 to clamp the truck rack 10 to the bedrail 32 of the truck 16, as best shown in FIGS. 26 and 27. As will be readily apparent to those skilled in the art, various mechanisms can be utilized to join the lower clamp assembly 204 to upper clamp assembly 206 than the threaded aperture 228 and screw 232 described above and shown in the figures. Any such mechanism should be chosen to be able to securely, but removably, join lower 204 and upper 206 clamp assemblies to allow the user to easily and quickly install rack 10 onto truck 16 or remove it therefrom as he or she may require or desire.

In the preferred configuration of clamping assembly 50, upper clamp assembly 206 comprises a channel member 238 that is fixedly attached to base member 94 so as to define an insert channel 240, as best shown in FIG. 12 with regard to the above embodiment, to receive insert member 212 therein. As set forth in the above embodiment, threaded screw 232 connects to insert member 212 through an aperture 244 in the top wall 242 of the channel member 238. The size of insert member 212 and insert channel 240 should be selected such that the two components cannot rotate relative to each other, or at least have very limited rotation, and for only limited lateral movement to each other. Because insert member 212 is slidably received in insert channel 240, as best shown in FIG. 11, the lower clamp assembly 204 may move horizontally relative to channel member 238 of upper clamp assembly 206, inside insert channel 240, so the user can easily adjust the location of the lower clamp assembly 204 in light of any obstruction that may be present under bedrail 32. As with the components of lower clamp assembly 204, channel member 238 of upper clamp assembly 206 should be manufactured out of metal or other materials having suitable strength, rigidity and corrosion resistance for the intended outdoor use on pickup truck 16 or which may be coated or treated with another material, such as by powder coating, to provide the desired corrosion resistance.

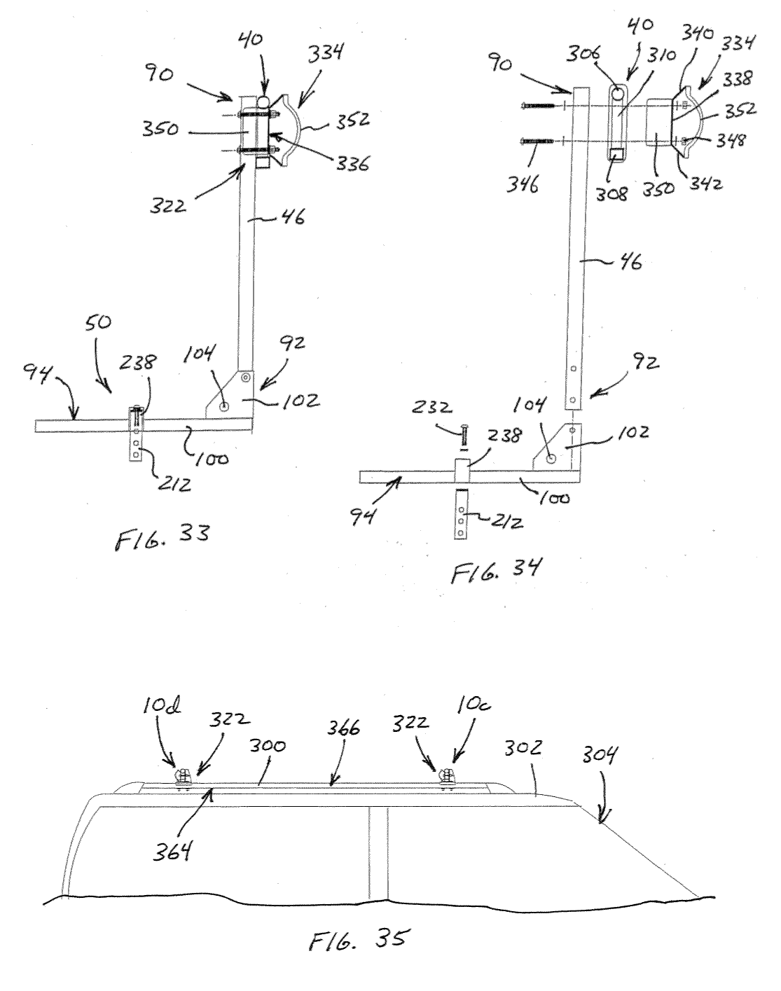

In an alternative configuration of clamping assembly 50 used with rack 10 of the present invention, shown in use on the right side of FIGS. 26 and 27, the rack 10 is secured to the truck 16 by utilizing the accessory track 122 that is provided by the manufacturer for some models of trucks 16. These accessory tracks 122 are provided with a slot 124 facing inward to rear cargo area 20 and are configured to be utilized with various accessory items, such as cleats, eye hooks and the like. For the present invention, the accessory track 122 and slots 124 therein are utilized with base member 94 to secure the first 12 and second 14 rack assemblies of truck rack 10 onto the bedrail 32 of the sidewalls 28 and 30. The use of the accessory track 122 is discussed above in conjunction with the embodiment shown in FIGS. 19 through 21. The present invention utilizes a clamping assembly 50 that is similar to that which is described above with regard to the clamping assembly 50 that secures the rack assemblies 12/14 of the present embodiment to the bedrails 32. As best shown in FIGS. 33 and 34, the clamp assembly 50 for use with accessory track 122 utilizes insert member 212 as the lower clamp assembly 204 and the channel member 238 as the upper clamp assembly 206. As described above, the insert member 212 is received in insert channel 240 of the channel member 238 and secured to channel member 238 and, therefore base member 94, with a threaded screw 232 or other device that is received through an aperture 244 in the top wall 242 of the channel member 238. Although the clamping assembly 50 can be configured as shown in FIGS. 20 through 21, the clamping assembly 50 of this embodiment comprises a track insert 332 that has a bolt-like component having a shaped head which is received in the accessory track 122 with a threaded portion that extends out of the accessory track 122 and passes through one of the apertures in the insert member 212 and engages nut 130, with one or more washers 132, to attach insert member 212 to the accessory track 122 on one of the sidewalls 28/30. The nut 130 is tightened to draw the track insert 332 and insert member 212 together and draw the vertical section 100 of base member 94 against the sidewall 28/30 near bedrail 32, as best shown in FIGS. 26 and 27, so as to secure the first 12 or second 14 rack assemblies to their respective sidewalls 28/30.

Although the foregoing description includes screws, bolts or bolt-like devices as the connecting mechanisms to clamp the lower 204 and upper 206 clamp assemblies together or attach to accessory track 122 when securing the base member 94 of truck rack 10 to the bedrail 32 of pickup truck 16, a variety of other connecting mechanisms can be utilized instead of the screws or bolts for clamping assembly 50 of the present invention. In a preferred embodiment, any such connecting mechanism includes some type of security feature to at least make it difficult for unauthorized persons to disengage clamping assembly 50 and remove truck rack 10 from pickup truck 16. In a preferred embodiment, a security feature is incorporated into the drive opening of the head of any screws or bolts. The security feature can be as simple as a Torx® or similar type of less common drive opening, compared to slotted or Phillips heads, that reduces the likelihood that a potential thief will be able to easily remove truck rack 10 from pickup truck 16. For additional security, the security feature can be selected to require the use of a specially configured driver that is not readily available to the public or the use of a custom made, proprietary driver that is not available to the public at all. As known in the art, tamper resistant screws and bolts utilize specially designed drive openings, some of which may include one or more upwardly extending pins therein for additional security, that can only be engaged by a cooperatively configured bit which is supplied to the user when ordering the screws or bolts. Many of the designs for the security feature are proprietary, such that only the user is supplied with the driver bits that fit the drive opening of the screw or bolt. Use of such proprietary features can essentially make clamping assembly 50 tamper proof. With a tamper resistant security feature, the user can be relatively confident that an unauthorized persons will not be able to disengage clamping assembly 50 to remove truck rack 10 from pickup truck 16.

As set forth above, the upper end 90 of each of the leg members 46 are secured to the span member 40 to dispose the span member 40 transversely across and above the rack support surface, typically bed 22 or roof 302. In one embodiment, the upper ends 90 of leg members 46 are fixedly attached to the span member 40. In the preferred embodiment, however, the upper ends 90 of leg members 46 removably attach to span member 40 utilizing a span engaging means, preferably a span clamp assembly 322, that is configured to releasably clamp the upper end 90 of each leg member 46 to span member 40. Preferably, the span engaging means is configured to vertically dispose span member 40, as shown in FIGS. 25, 29 and 33, or at least substantially place span member 40 in a vertical orientation so one of the first 306 and second 308 mounting crossbars will be disposed above the other crossbar 306/308 to position one of the crossbars 306/308 as the primary crossbar to which one or more accessory attachments can be attached.

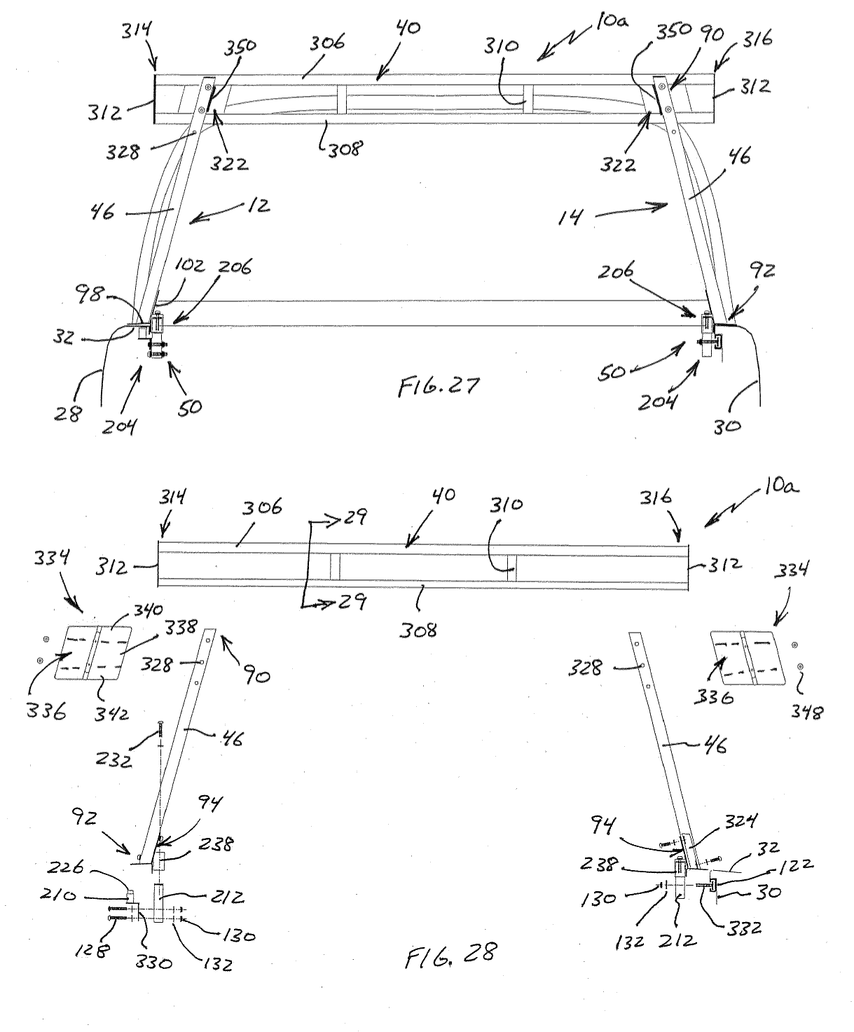

In the preferred embodiment of the present invention, the rack 10 includes a gripping assembly 334 that grips or clamps against the first 306 and second 308 mounting crossbars of span member 40, as best shown in FIGS. 25 through 27 and 33. A preferred gripping assembly comprises a grip plate 336 that has a substantially vertical center section 338, an angled upper section 340 and an angled lower section 342, as best shown in FIGS. 28 and 34. The grip plate 336 has one or more, preferably a plurality, of apertures 344 in center section 338. Each of the apertures 344 are sized and configured to receive a bolt or other connector, shown as 346. The connector 346 extends from one side of the grip plate 336 through the apertures 344 and the span connecting apertures 328 at the upper ends 90 of leg members 46 to be engaged by a nut or like connector engaging device 348. When the nut 348 is tightened, the grip plate 336 is drawn against the span member 40 to clamp the span member 40 to the upper ends 90 of leg members 46. Although grip plate 336 can be planar or substantially planar, use of the angled upper 340 and lower 342 sections thereof more securely clamps the grip plate 336 to the span member 40. As shown in FIGS. 25 and 33, the angled upper 340 and lower 342 sections of grip plate 336 engage the first 306 and second 308 mounting crossbars, respectively, to secure the upper ends 90 of leg members 46 to span member 40.

The preferred gripping assembly 334 also includes a leg engaging plate 350 attached to the back side of grip plate 336 (the back side being the side that faces away from the direction of angled upper 340 and lower 342 sections), as best shown in FIGS. 26, 27, 33 and 34. The leg engaging plate 350 is sized and configured to extend in the space between the first 306 and second 308 mounting crossbars and be engaged by the side of the upper end 90 of leg members 46 to provide additional support for leg members 46 as they incline inward from sidewalls 28/30. In one embodiment, the grip plate 336 is made out of metal and the leg engaging plate 350 is welded to the grip plate 336. The leg engaging plate 350 is disposed on grip plate 336 at an angle that corresponds to the angle of incline, relative to the sidewalls 28/30, for the leg members 46. The preferred embodiment of gripping assembly 334 also includes a tie-down loop 352, as best shown in FIGS. 25, 33 and 34, on the front side of the grip plate 336 that can be utilized to secure the load being carried to the rack 10.

The embodiment of rack 10 as a roof rack, with racks 10c and 10d, is best shown in FIGS. 35 through 39. The roof rack 10c/10d is configured in much the same manner as the truck rack 10a/10b described above and shown in FIGS. 26 through 34. For instance, span member 40 for roof rack 10c/10d is configured the same as for truck rack 10a/10b with the first 306 and second 308 mounting crossbars and a crossbar spacing member 310 to maintain the two crossbars 306/308 in spaced apart relation. End plates 312 at the first 314 and second 316 ends of span member close the tubular mounting crossbars 306/308 and provide additional strength and stability to span member 40. The rack mounting means, preferably comprising clamp assembly 50, at the lower end 92 of leg members 46 removably clamp the leg members 46 to cargo rails 300 and the span engaging means, preferably span clamp assembly 322, at the upper end 90 of the leg members 46 removably clamp the leg members 46 to the span member 40 to dispose the span member 40 transversely across and above the roof 302 of the cab 18 of pickup truck 16 or the roof 302 of the SUV 304. In the embodiment of rack 10 as a roof rack 10c/10d the leg members 46 will be substantially shorter than those utilized with the truck rack 10a/10b. As well known in the art, typically the roof rack 10c/10d extends upwardly above the roof 302 as short a distance as possible to minimize the height of any load carried thereon. In one embodiment, the leg members 46 of the roof rack 10c/10d is approximately two to four inches. As with the above truck rack embodiment, in a preferred configuration of the roof rack embodiment span clamp assembly 322 cooperates with the leg members 46 to dispose the span member 40 in a generally vertical position with one of the mounting crossbars 306/308 positioned generally above the others. In the preferred embodiment, the span clamp assembly 322 also comprises gripping assembly 334 having grip plate 336 with the center section 338, inclined upper section 340 and inclined lower section 342. As with the above embodiment, the grip plate 336 has an aperture 344 through which a bolt or other connector 346 is disposed to connect to nut 348 or other connector engaging device to clamp the grip plate 336 against the span member 40 with the angled upper 340 and angled lower 342 sections of grip plate pressed against the first 306 and second 308 mounting crossbars, respectively. As described above, the span clamp assembly 322 allows the user to select which of first 306 or second 308 mounting crossbars he or she desires to have above the other crossbar 306/308 to use for mounting one or more accessory attachments to rack 10. If desired, the tie-down loop 352 can also be utilized with roof rack 10c/10d. Typically, leg engaging plate 350 will not be necessary due to the short height of leg member 46 usually utilized with the roof rack 10c/10d embodiment of rack 10.

As best shown in FIGS. 36 through 39, the different configuration of cargo rails 300, compared to the bedrails 32 and accessory tracks 122, requires a different configuration for the clamping assembly 50. In a preferred embodiment, the lower clamp assembly 204 comprises a lower clamp plate 354 having one or more apertures 356, shown in FIG. 38, for receiving bolt 346 and the upper clamp assembly 206 comprises the horizontal section 98 of base member 94 with one or more apertures 358, shown in FIG. 39, through which the bolt 346 passes. As shown in FIG. 36, the bolt 346 passes through the horizontal section 98 of base member 94 and the lower clamp plate 354 to engage a nut 348. Cargo rail 300 is disposed between the bottom of the horizontal section 98 and the top of the lower clamp plate 354, which engages the underside surface 364 of cargo rails 300. When nut 348 is tightened on bolt 346, the horizontal section 98 of base member 94 and the lower clamp plate 354 are clamped toward each other around the cargo rail 300 to secure the clamping assembly 50 to cargo rail 300, as shown in FIGS. 35 and 36. The lower clamp plate 354 has a downward projecting section 360, which generally corresponds to the vertical section 100 of base member 94 utilized with the embodiment described above for truck rack 10a/10b, which abuts an edge 366 of the cargo rails 300. As shown in FIGS. 35 and 36, the cargo rail 300 is placed such it is disposed between the bolt 346 and downwardly projecting section 360, thereby preventing and left to right movement of rack 10c/10d when mounted on cargo rail 300. In the preferred embodiment of clamp assembly 50 for the cargo rails 300, the lower clamp plate 354 also has an upwardly projecting section 362, best shown in FIGS. 36, 37 and 39, that is utilized to provide an upward bending resistance force to the bottom of span member 40 to help resist any bending of span member 40 as a result of heavy loads on rack 10c/10d. In this embodiment, the lower end 92 of leg member 46 is, preferably, fixedly attached to or integrally formed with the top side of the horizontal section 98 of the base member 94, which eliminates the need to utilize a tubular leg member 46 having an open lower end 92 and a tube engaging member 324 that is received inside the open lower end 92 of leg member 46, as described above with regard to the truck rack 10a/10b embodiment.

As noted above, the components of the first rack assembly 12 and the second rack assembly 14 are the same for the different embodiments. The use of the same major components for each rack assembly 12/14, including but not limited to the span member 40, clamping assemblies 50 and span clamp assemblies 322, provides interchangeability between the two rack assemblies 12/14 and reduces the cost of manufacturing and reduces the amount inventory that must be kept by a supplier or distributor. In fact, the components of the truck rack 10a/10b embodiment are substantially the same, at least with regard to their configuration, as the components for the roof rack 10c/10d embodiment. As set forth above, the primary differences between the truck rack 10a/10d and the roof rack 10c/10d are the length of the leg members 46, the configuration of the base member 94 and the connection between the leg members 46 and base member 94. The clamping assemblies 50, while configured different due to differences between the bedrails 32 or accessory tracks 122 and the cargo rails 300, are both configured to removably clamp onto their respective rack mounts.

A variety of other alternative embodiments can be configured for the rack 10 of the present invention. For instance, the span member 40 and/or the leg members 46 can be telescoping to allow additional flexibility with regard to the width to span and/or the height placement for span member 40. Alternatively, the mounting crossbars 306/308 can be provided in multiple sections that are stored and shipped separately and then connected together when utilized as rack 10 on a pickup truck 16, SUV 304 or other vehicle. If multiple crossbars 306/308 and/or leg members 46 are utilized, they can be configured for the user to select the desired length of these components that best fit his or her vehicle. The clamping assembly 50 and/or span clamp assembly 322 are also subject to a variety of different modifications to the embodiments described above and/or other types of clamping assemblies can be utilized to secure rack 10 of the present invention to the bedrails 32, accessory track 122 or cargo rails 300 of a vehicle. Although the preferred embodiment of the present invention has the mounting crossbars 306/308 with one of the mounting crossbars 306/308 positioned generally above the other, they can be configured with the two mounting crossbars 306/308 in a horizontal relationship (i.e., substantially in the same plane) or disposed generally horizontal with one of mounting crossbars 306/308 only slightly above the other. The span clamp assembly 322 or other span mounting means for each rack assembly 12/14 can be configured to dispose the mounting crossbars 306/308 generally horizontal, preferably in spaced apart relation so one or more of the accessory attachments can removably attach to the mounting crossbars 306/308. As with the preferred embodiment, one or more crossbar spacing members 310 can be utilized to maintain the mounting crossbars 306/308 with the desired spacing therebetween.

In use, the user will typically assemble the truck racks 10a/10b by first connecting the lower end 92 of the leg members 46 to a base member 94 by inserting the tube engaging member 324 inside the leg member 46 and then connecting these components with the one or more connectors 326. The user will then loosely connect the upper end 90 of each leg members 46 to the span member 40 utilizing the span clamp assembly 322. The span member 40 is connected to leg members 46 with the desired mounting crossbar 306/308 above the other mounting crossbar 306/308 so the mounting crossbar 306/308 which is needed to connect to the accessory attachments is on top (i.e., positioned above the other mounting crossbar 306/308). The grip plate 336 is placed against the span assembly 40 with the angled upper section 340 thereof against the upper of the two mounting crossbars 306/308 and the angled lower section 342 thereof against the lower of the two mounting crossbars 306/308. If the rack 10a/10b will be supported by the bedrails 32, as opposed to the accessory track 122, the user connects the insert member 212 to the L-shaped brace member 330 and, if necessary, attaches the cushioning member 226 to the upper end of engaging member 210.

The base member 94 of each of the first 12 and second 14 rack assemblies is then placed onto the bedrails 32 of the sidewalls 28 and 30, with the horizontal section 98 resting on the top surface 34 of bedrail 32 and the vertical section 100 against lip 36 of bedrail 32. The user will then typically secure the clamping assembly 50 to the bedrails 32 or the accessory track 122 at the location where the rack 10a/10b is desired by clamping the insert member 212 against the bedrails 32 or accessory track 122. Once in place on sidewalls 28/30, the user will then tighten the span clamp assemblies 322 to fix the position of span member 40 across and above the bed 22 of pickup truck 16, preferably with the span member 40 substantially centered over bed 22. With regard to the roof racks 10c/10d, the user will install these racks 10c/10d in much the same manner. First the user loosely joins together the components of the clamping assembly 50 and then loosely connects the span clamp assembly 322 to the span member 40 (with the desired mounting crossbar 306/308 on top). The user then attaches the clamping assembly to the cargo rails 300 at the location where he or she desires to have racks 10c and 10d. The span clamp assembly 322 is tightened, as described above, to clamp the leg member 46 to the span member 40 to dispose the span member 40 transversely across and above the roof 302 of the vehicle 16/304. In either embodiment, once the rack 10 is affixed to the bedrails 32, accessory track 122 or cargo rail 300 of the vehicle 16/304, the user can then attach one or more accessory attachments so he or she can secure one or more canoes, kayaks, ladders, bicycles, snow boards, skis or other items to the rack 10. Removal of rack 10 from the vehicle 16/304 is accomplished by generally reversing the installation steps set forth above.

As will be readily apparent to those skilled in the art, rack 10 of the present invention has numerous advantages over prior art truck and roof racks. Many of the advantages of the present invention are the same as those that have been described with regard to the embodiments of the truck rack shown in FIGS. 1 through 24. These include the ability to quickly and easily assemble the rack 10 on a vehicle 16/304 and to disassemble the rack 10 into relatively small, easy to handle, store and ship components. The configuration of rack 10 allows the user to carry heavy loads while allowing the manufacturer to utilize lightweight materials for the components of the rack 10. Only a few screws, bolts or other connecting elements are required to connect the various components into rack 10. The clamping assembly 50 allows use of rack 10 with vehicles 16/304 having conventional bedrails 32, sidewalls 28/30 with accessory tracks 122 and roofs 302 having cargo rails 300. The clamping assemblies 50 utilized with the rack 10 of the present invention removably clamps rack 10 to the vehicles 16/304 without utilizing the stake pockets 38 or requiring any holes or other modifications to be made to the bedrails 32, accessory track 122 or cargo rails 300 of the vehicle 16/304. The preferred clamping assemblies 50 are compact so as to not interfere with ropes or other cargo securing devices and resist being knocked loose by any movement of the cargo. The clamping assemblies do not interfere with the use of tool boxes or other accessories that sit on the bedrail 32 of the truck 16. One benefit of rack 10 is that it can be quickly and easily moved from one vehicle 16/304 to another for use thereon. One of the primary benefits of the rack 10 of the present invention is the use of the dual mounting crossbars 306/308. Use of the two crossbars 306/308 allows the user to select which crossbar to utilize as the upper or primary crossbar, which will be the crossbar to which one or more accessory attachments can be attached to carry items thereon. This allows the user to select the most desirable accessory attachments without being limited to those available from the manufacturer of his or her rack system. In addition, the rack 10 of the present invention much simplifies the borrowing of accessory attachments for use on another vehicle 16/304 or the borrowing of a vehicle 16/304 and the use of a person's accessory own attachments.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

What is claimed is:

1. A rack for a vehicle having a rack support surface with a first rack mount and a spaced apart second rack mount disposed thereon, said rack comprising:
an elongated span member having a first end and a second end, said span member comprising a first mounting crossbar and a second mounting crossbar disposed in spaced apart relation, said first mounting crossbar having a first cross-section and said second mounting crossbar having a second cross-section;
a first rack assembly having a leg member, a rack mounting means disposed at or near a lower end of said leg member for mounting said rack assembly to said first rack mount and a span engaging means disposed toward an upper end of said leg member for engaging said span member generally towards said first end of said span member to attach said span member and said leg member together; and
a second rack assembly having a leg member, a rack mounting means disposed at or near a lower end of said leg member for mounting said second rack assembly to said second rack mount and a span engaging means disposed toward an upper end of said leg member for engaging said span member generally towards said second end of said span member to attach said span member and said leg member together,
wherein said first rack assembly and said second rack assembly support said span member above said rack support surface with said span member disposed generally transversely across and above said rack support surface.

2. The rack according to claim 1, wherein said rack support surface is one of a bed and a roof of said vehicle and each of said first rack mount and said second rack mount is one of a bedrail, accessory rack and cargo rail on said vehicle.

3. The rack according to claim 2, wherein each of said rack mounting means is a clamp assembly configured to removably clamp each of said leg members to its respective said bedrail, said accessory track or said cargo rail.

4. The rack according to claim 1 further comprising a crossbar spacing means interconnecting said first mounting crossbar and said second mounting crossbar for maintaining said first mounting crossbar and said second mounting crossbar in spaced apart relation.

5. The rack according to claim 1, wherein said span engaging means of said first rack assembly clamps together said span member and said leg member of said first rack assembly and said span engaging means of said second rack assembly clamps together said span member and said leg member of said second rack assembly.

6. The rack according to claim 1, wherein said span engaging means of said first rack assembly is configured to releasably clamp said span member to said upper end of said leg member and said span engaging means of said second rack assembly is configured to releasably clamp said span member to said upper end of said leg member.

7. The rack according to claim 6, wherein each of said span engaging means comprises a span clamp assembly having a grip plate configured to engagedly clamp against said span member.

8. The rack according to claim 7, wherein each of said grip plates comprises an angled upper section configured to engage one of said first mounting crossbar and said second mounting crossbar and an angled lower section configured to engage the other of said first mounting crossbar and said second mounting crossbar.

9. The rack according to claim 7, wherein each of said span clamp assemblies further comprises a leg engaging plate attached to said grip plate, said leg engaging plate configured to be placed in abutting relation to said upper end of one of said leg members when said grip plate is clamped against said span member.

10. The rack according to claim 1, wherein said span engaging means of said first rack assembly and said span engaging means of said second rack assembly are configured to dispose said span member with one of said first mounting crossbar and said second mounting crossbar above the other of said first mounting crossbar and said second mounting crossbar.

11. The rack according to claim 1, wherein said first cross-section is in contrasting relation to said second cross-section.

12. A rack for a vehicle having a rack support surface with a first rack mount and a spaced apart second rack mount disposed thereon, said rack comprising:
an elongated span member having a first end and a second end, said span member comprising a first mounting crossbar, a second mounting crossbar and a crossbar spacing means interconnecting said first mounting crossbar and said second mounting crossbar for maintaining said first mounting crossbar and said second mounting crossbar in spaced apart relation, said first mounting crossbar having a first cross-section and said second mounting crossbar having a second cross-section, said first cross-section in contrasting relation to said second cross-section;
a first rack assembly having a leg member, a clamping assembly at or near a lower end of said leg member and a span clamp assembly at an upper end of said leg member, said clamping assembly configured to clamp said first rack assembly to said first rack mount and said span clamp assembly configured to clamp said leg member of said first rack assembly to said first end of said span member; and
a second rack assembly having a leg member, a clamping assembly at or near a lower end of said leg member and a span clamp assembly at an upper end of said leg member, said clamping assembly configured to clamp said second rack assembly to said second rack mount and said span clamp assembly configured to clamp said leg member of said second rack assembly to said second end of said span member,
wherein said first rack assembly and said second rack assembly support said span member above said rack support surface with said span member disposed generally transversely across and above said rack support surface with one of said first mounting crossbar and said second mounting crossbar disposed generally above the other of said first mounting crossbar and said second mounting crossbar.

13. The rack according to claim 12, wherein said rack support surface is one of a bed and a roof of said vehicle, each of said first rack mount and said second rack mount is one of a bedrail, accessory rack and cargo rail on said vehicle and each of said clamping assemblies are configured to clamp each of said leg members to its respective said bedrail, said accessory track or said cargo rail.

14. The rack according to claim 12, wherein each of said span clamp assemblies has a grip plate configured to engagedly clamp against said span member to secure said leg member to said span member.

15. The rack according to claim 14, wherein each of said grip plates has an angled upper section configured to engage one of said first mounting crossbar and said second mounting crossbar and an angled lower section configured to engage the other of said first mounting crossbar and said second mounting crossbar.

16. The rack according to claim 14, wherein each of said span clamp assemblies further comprise a leg engaging plate affixed to said grip plate, said leg engaging plate configured to be placed in abutting relation to said upper ends of said leg members when said grip plate is clamped against said span member.

17. The rack according to claim 12, wherein each of said span clamp assemblies are configured to dispose said span member with one of said first mounting crossbar and said second mounting crossbar substantially vertically above the other of said first mounting crossbar and said second mounting crossbar.

18. A rack for a vehicle having a rack support surface with a first rack mount and a spaced apart second rack mount disposed thereon, said rack comprising:
an elongated span member having a first end and a second end, said span member comprising a first mounting crossbar, a second mounting crossbar and one or more crossbar spacing members disposed between and interconnecting said first mounting crossbar and said second mounting crossbar so as to maintain said first mounting crossbar and said second mounting crossbar in spaced apart relation, said first mounting crossbar having a first cross-section and said second mounting crossbar having a second cross-section, said first cross-section in contrasting relation to said second cross-section;
a first rack assembly having a leg member, a clamping assembly at or near a lower end of said leg member and a span clamp assembly at an upper end of said leg member, said clamping assembly comprising a base member configured to clamp said leg member of said first rack assembly to said first rack mount, said span clamp assembly having a grip plate configured to clamp said first rack assembly to said first end of said span member; and
a second rack assembly having a leg member, a clamping assembly at or near a lower end of said leg member and a span clamp assembly at an upper end of said leg member, said clamping assembly comprising a base member configured to clamp said leg member of second rack assembly to said second rack mount and said span clamp assembly having a grip plate configured to clamp said second rack assembly to said second end of said span member,
wherein said first rack assembly and said second rack assembly support said span member above said rack support surface with said span member disposed generally transversely across and above said support surface with one of said first mounting crossbar and said second mounting crossbar disposed generally vertically above the other of said first mounting crossbar and said second mounting crossbar.

19. The rack according to claim 18, wherein each of said grip plates has an angled upper section configured to engage one of said first mounting crossbar and said second mounting crossbar and an angled lower section configured to engage the other of said first mounting crossbar and said second mounting crossbar.

20. The rack according to claim 19, wherein each of said span clamp assemblies further comprise a leg engaging plate affixed to said grip plate, said leg engaging plate configured to be placed in abutting relation to said upper ends of said leg members when said grip plate is clamped against said span member.
